(19) United States
(12) Patent Application Publication
(10) Pub. No.: US 2016/0034936 A1
(43) Pub. Date: Feb. 4, 2016

(54) SOCIAL-REFERRAL NETWORK METHODS AND APPARATUS

(71) Applicants: Thomas BRYANT, III, Round Rock, TX (US); Henry PENA, Round Rock, TX (US); William BRECK, Reno, NV (US)

(72) Inventors: Thomas BRYANT, III, Round Rock, TX (US); Henry PENA, Round Rock, TX (US); William BRECK, Reno, NV (US)

(21) Appl. No.: 14/777,449

(22) PCT Filed: Mar. 14, 2014
(86) PCT No.: PCT/US14/27153

§ 371 Date: Sep. 15, 2015

Related U.S. Application Data
(60) Provisional application No. 61/800,679, filed on Mar. 15, 2013.

(51) Int. Cl. G06Q 30/02; H04L 29/08; G06Q 50/00; H04L 29/06

(52) U.S. Cl. CPC G06Q 30/0214; H04L 65/403; H04L 67/02; G06Q 50/01

(57) ABSTRACT

A computer implemented method, apparatus and computer readable medium for monetizing online referral social networks. The online referral social network system confirms a particular online referral social network member indicated in one or more communications for registering a user as having referred the user to the online referral social network is a member of said online referral social network. A referral commission is determined and paid the particular identified referring member.

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

1. Field

Embodiments relate to social networks and, more particularly but not exclusively, to social network monetization. Embodiments also relate to social network user information database generation and searching tools.

2. Description of Related Art

Social networks of many kinds have been created on the Internet, with most using a ‘business model’ that is less than optimal from a financial (aka “monetization”) perspective, ranging from an ‘advertising model’ to a ‘charge-for-use model’ to a ‘pay-for-play model’, none of which optimize the financial capacity of the social network to make money (i.e., to “monetize”) for the benefit of those who participate in the ‘social network’ as well as its owner-operators.

In the ‘advertising model’ ‘social network’ people are invited or enticed to join the ‘social network’ website for free, to become and remain a ‘member’ of the ‘social network’ website, and to use the ‘social network’ for its designed purpose or purposes without cost to the member. This is, in essence, the “Facebook Model”, which is arguably the most successful expression to date of the ‘advertising model’ of ‘social network’ website.

In the Facebook Model, since it is free to join, to become and remain a member and to use the social network, the typical sole remaining source of revenue available to the owner-operators is the advertising revenue derived from those persons and companies who wish to display an ‘advertisement’ on the social network's website. Nevertheless the Facebook Model provides a valuable service to its members, by permitting the free publication and exchange of non-commercial and commercial information between its members, even though it is less than optimal from the financial or “monetization” perspective.

A second type of website (but one that is generally not considered to be a “social network”) is the “Research Model”. The Research Model website may offer some ‘information’ for free, but typically charges for access to most of the information on the website, or if access is provided for free, the website charges for the ability to copy or print information from the website. Almost all government websites, and most other websites currently available online, use either the “advertising model” or the “Research Model”.

However, since there is no “social sharing” of information or experience, the Research Model website is not, in any substantial sense, a “social network”. Most newspapers, research websites and other sources of information available on the Internet use either the “Advertising Model” (where revenues are dependent on ‘advertisers’) or the “Research Model” where some information is available for free, but the user must pay to join or to download, in order to obtain access to non-free information or to download and print the ‘information’ that is found on the website.

However, a subset of the “Research Model” website may be considered to be a ‘social network’ to a certain extent. That is the “Dating Network Model”. In the Dating Network Model it is typically free to join and browse or search for potential ‘dates’ or ‘mates’, but the contact information is withheld until payment of a fee is received by the website. Thus, the website owner or operator can make a small profit when the potential ‘dates’ or ‘mates’ meet for the first time online, but the cash flow is ‘one time’ (per contact) and ‘one way’ (from user to website owner-operator). While such sites may be profitable (and some Dating Network websites are reputed to be very profitable), they have not truly monetized the website to its maximum capacity.

Another kind of ‘social network’ (using the term loosely) is represented by the “Sex Site Model”. In the Sex Site Model, the user typically pays for access in order to see photos or movies of (and sometimes observes through live webcams and may communicate in some manner, by voice or typed instant messages) people in sexually stimulating poses, or engaged in sexually provocative activities. But, once again, although the Sex Site Model has produced many financially successful websites, and it has not monetized the website to its maximum capacity.

And, the final kind of ‘social network’ (again using the term loosely) is represented by the “Gaming Site Model”. In one version of the “Gaming Site Model” the user is enticed or invited to establish an account by using a credit or debit card to buy ‘credits’ which are then used to gamble online in a ‘virtual casino’. In another version of the ‘Gaming Site Model’ participants play against each other, or against a virtual opponent, and some games can involve a significant number of players. Thus, the Gaming Site Model may be a quasi-‘social network’ to the extent that it permits or facilitates its participants to ‘play against each other’, and thus involves the interactions of multiple participants. Although the “Gaming Site Model” has been used to establish many financially successful websites and it has not monetized the website to its maximum capacity.

There is a need to provide improved apparatus and methods for social network monetization.

### SUMMARY

In contrast to the “business models” of the various kinds of “social networks” described above (i.e., the “traditional business models”), the invention seeks to turn the traditional business models on their heads, by providing a mechanism in which the participants “make money” rather than, or in addition to, the owner-operators.

Unless otherwise stated, a “user” as referred to hereinafter refers to such a participant of the referral social network and not an owner-operator of the referral social network. Unless otherwise stated, a “member” or “prospective member” as referred to hereinafter refers to such a participant that is a member or prospective member of the referral social network and not an owner-operator member of the referral social network.

According to one aspect, there is provided a computer implemented method for monetizing an online social network. The method can comprise receiving, by the online referral social network from a user over a computer network, at least one communication requesting access to the online referral social network and/or t least one online good or service; receiving, by said online referral social network, at least one communication indicating a particular member of said online referral social network as having referred the user to said online referral social network; confirming, by said online referral social network, a particular online referral social network member indicated in said at least one communication as having referred the user to the online referral social network is a member of said online referral social network; providing online access to good or service user interface for procuring said good or service through said referral online social network; determining, by said online referral social network, a referral commission; and paying, by said online referral social network, a referral commission to at least the particular identified referring member.

An interface can be provided by the online referral social network system that allows a user of the system to retrieve information from a separate system using one interface. Many contacts and connections may now be completed electronically, which reduces redundant data entry and mistakes made by multiple manual inputs. Clients and potential clients may indicate specific key word(s), key phrase(s) or key function(s) information. Clients can target and refer, either personally and/or electronically, their personal and social networking contacts and connections through the system according to specific key word(s), key phrase(s) or key function(s) information. The system utilizes specific key word(s), key phrase(s) or key function(s) information indicated by clients and potential clients to target clients and potential clients as potential new members. Clients may be automatically contacted with specific event information relevant to a business, special sales, and timeslot openings, etc. A client may respond electronically to order and offer time slots, products and services, make requests, etc. A client may interact in multiple ways with other clients. A client may increase their list(s) of contacts and connections and potential subscribers. All clients can leverage their contacts and connections and the contacts and connections of other clients as potential subscribers. All clients can be advertised to as potential subscribers.

According to another aspect, there is provided herein a database management system configured to return all referrals between members from a single database call.

According to another aspect, there is provided a method for an online referral social network. The method can comprise for each one of plurality of members in a referral social network: determining from referral information of the online referral social network a combined number of referrals downline and/or upline from a member; and storing in a one call database, the combined number of referrals downline and/or upline from the member and the identity of the member; receiving a request to determine a commission payable to at least a referring member; in response to receiving the request, obtaining in a single database call from the one call database, the combined number of referrals upline and/or downline from the referring member; and determining a commission payable to at least the referring member utilizing said obtained combined number of referrals.

According to another aspect, there is provided a computer implemented method for monetizing online social networks, the online multi referral social network comprising a plurality of referral social networks, each referral social network of said plurality being customized for use with a particular external social network. The method can comprise receiving, by said online multi referral social network, at least one communication for registering said user with a selected one of said plurality of customized referral social networks; said at least one communication including an indication of a particular member of said online multi referral social network as having referred the user to the online multi referral social network; confirming, by said online multi referral social network, a particular online referral social network member indicated in said at least one communication as having referred the user to the online referral social network is a member of said online multi referral social network; determining, by said online multi referral social network, a referral commission; and paying, by said online multi referral social network, a referral commission to at least the particular identified referring member.

According to yet another aspect, there is provided an apparatus for monetizing at least one online social network. The apparatus can comprise one or more processors operably connectable to at plurality of user devices; a data bus coupled to said processor(s); a computer-usable medium embodying computer program code, said computer-usable medium being coupled to said data bus; and said computer program code comprising instructions executable by said processor and configured for performing one or more of the methods of the aforementioned aspects.

According to yet another aspect, there is provided a computer-readable medium including contents that are configured to cause a computing system to monetize at least one online social network by performing one or more of the aforementioned method aspects.

According to yet another aspect, there is provided herein an online referral social network website in which members are incentivized to refer other individuals to join the referral social network. Members build their social network by establishing contacts with other members, and build a database reflecting their contacts and referred members (“referrals”). Members can build their network based on categories of interest etc. to help them connect to others with similar interests. Keyword searching can be used to find out what users show preference for, such as movies, music, games, computers, software, sports, hobbies, travel, food, or social causes such as politics, environmental issues, and the like. According to embodiments, a user can enter a search term and be able to connect with other people who have indicated in a social network profile the search term or related terms as their own interest. Referral relationships between members are described herein as being either “upline” or “downline.” A member who refers another member to the referral social network is upline to the referred member, and the member referred by the upline member is downline of the upline member. By chaining together referrals in multiple iterations, for example an upline member is associated with a downline member who also is upline to yet another member, continuing for a desired number of associations in a vertical/sequential chain, individual members' referral lists can grow exponentially. Compensation for referral is a key aspect of the referral social network described herein, and is distributed based on successfully referring new members to the referral social network. As a member's network of contacts with other members within the referral social network grows, so does their earning potential as compensation is distributed in a vertical manner among a chain of referred members.

In other embodiments, multiple compensation distribution models are contemplated herein. The rate of compensation for the first level of downline referrals may be higher for the anchor referring member than the second level of downline referrals, but the compensation rates may also be equal, or, in an embodiment, increased as additional referral levels grow. Compensating members for new member referrals thus quickly populates the referral social network, and allows members to establish direct contact with other members.

In another aspect, a database structure and management method thereof is presented herein. As described herein, the database of the referral social network is maintained by a server in communication with multiple clients over a computer network, and maintains member profile information for individual members that are collected when a member joins the referral social network. Member profile information includes the member's identity, such as a screen name, and the identity (if any) of an upline member who referred the member. In one embodiment, compensation is offered to a referring member upon the user joining and upgrading to a paying membership to a referral social network. In another embodiment, compensation is offered to a new member upon joining the referral social network for identifying the upline member. This incentive preserves the vertical chain among members. Member profile information also may include personal interests such as described above. Member profile information also may include other information a user wishes to include on his or her individual profile, such as personal interests, either chosen from a menu presented to the user during a sign-up process, or user-supplied, or collected from a connected social network, for example, using Facebook Connect. Besides personal interests, information describing the user also may be included, such as gender, age, geographical location, what sort of housing the member resides within, resume items such as work history, education, family relationships such as number and ages of children, marital status, and the like. Group membership, political beliefs, religious beliefs, social issues of interest to a member, and the like, may also be listed in a member profile. Items possessed by the member, or simply items that interest the member (for example a ‘want” list), may also be listed on the member's profile. For example, a member may list automobiles, motorcycles, bicycles, consumer electronics, durable goods such as appliances, sporting goods, musical instruments, and the like, also may be included on a member profile. Member profile information can also include referral information associated with the individual member. For example, the member profile information may include referral relationships specific to individual members, identifying them within referral chains as upline or downline, the level within a referral chain where the member is placed, how many referral chains include the member, a current amount of compensation from referrals that is accrued by the member, a compensation target provided by the member or a group to which a member belongs, and a member's individual progress toward the target.

The database of the referral social network organizes the member profile information in searchable fields categorizing the individual membership items described above. This allows keyword searching to identify members to a searching member based on common interests, which facilitates establishing personal contacts. The database also stores referral relationships specific to individual members, identifying them within referral chains as upline or downline, the level within a referral chain where the member is placed, how many referral chains include the member, a current amount of compensation from referrals that is accrued by the member, a compensation target provided by the member or a group to which a member belongs, and a member's individual progress toward the target.

Many other features and advantages of the present invention will become apparent to one skilled in the art upon reading the following detailed description, when considered in conjunction with the drawings.

### DESCRIPTION OF THE DRAWINGS

FIG. 1 illustrates a generalized block diagram of an embodiment of a referral social network system provided by a social network in which the system maintains member referral and commission tools and enables social network members to be compensated for referrals;

FIG. 2 illustrates in block diagram form a network of user devices and server devices and equipment for implementing an online referral social network of FIG. 1 according to one embodiment;

FIG. 3 illustrates major software modules utilized to administer an online referral social network application of the social network system of FIG. 1 according to one embodiment.

FIG. 4 illustrates an exemplary member profile generated by the referral social network system of FIG. 1 according to one embodiment;

FIG. 5 illustrates an exemplary user interface generated by the referral social network system of FIG. 1 according to one embodiment;

FIG. 6 illustrates an exemplary org chart for representing referral relationships between members of the referral social network system according to one embodiment;

FIGS. 7-14 illustrate exemplary data structures for use within databases utilized in an online referral social network;

FIG. 15 illustrates a method for monetizing the referral social network system of FIG. 1 according to one embodiment;

FIGS. 16 & 17 illustrate a method for monetizing the referral social network system of FIG. 1 according to one embodiment;

FIG. 18 is an exemplary user interface screen showing a login screen linking an external social network account to the referral social network according to one embodiment;

FIG. 19 is an exemplary user interface screen showing an income calculator to incentivize prospective members to join the referral social network according to one embodiment;

FIG. 20 is an exemplary user interface screen showing an information gathering tool that presents other individuals with whom a prospective or new member may establish contact by following or subscribing to their “news feed” and that allows the member to begin engaging in referral processes based on keyword searches;

FIG. 21 illustrates a method for referring a user to the online referral social network according to one embodiment;

FIG. 22 illustrates an exemplary screen shot of a third party game user interface including a referring tab for referring the game to other users according to one embodiment;

FIG. 23 illustrates an exemplary screen shot of a third party game user interface including a referring tab for referring the game to other users according to another embodiment;

FIG. 24 illustrates an exemplary screen shot of a login user interface of the referral social network according to one embodiment;

FIGS. 25 & 26 illustrate exemplary screen shots of commercial venue application user interface implementing an invite process through according to one embodiment;

FIG. 27 illustrates an exemplary screen shot of a login interface of the referral social network according to one embodiment;

FIG. 28 illustrates an exemplary screen shot of a game referral user interface of the referral social network according to one embodiment;

FIG. 29 illustrates in flow chart form a method of determining referral commissions based on upline referrals according to one embodiment;

FIG. 30 illustrates an exemplary referral social network upline database table of a one call database according to one embodiment;

FIG. 31 illustrates in flow chart form a method of determining referral commissions based on downline referrals according to one embodiment;

FIG. 32 illustrates an exemplary referral social network downline database table of a one call database according to one embodiment;

FIG. 33 illustrates a block diagram of a referral social network application module and associated databases of an online multi referral social network system according to another embodiment;

FIG. 34 illustrates a user interface of the multi referral social network system according to one embodiment;

FIG. 35 illustrates in flow chart form acts performed for viewing referrals/commissions for targeted members across a plurality of customized referral social networks of the multi referral social network system according to one embodiment;

FIG. 36 illustrates in flow chart form acts performed for referring users to good or services via a referral social network of the multi referral social network system according to one embodiment;

FIG. 37 illustrates in flow chart form acts performed to install the software application of an embodiment of an online referral social network;

FIG. 38 illustrates in flow chart form acts performed to identify prospective users and sign them up in an online referral social network;

FIG. 39 illustrates in flow chart form acts performed for prebuilding subscribers in an online referral social network;

FIG. 40 illustrates in flow chart form acts performed for implementing a join process in which new members join an online referral social network;

FIG. 41 illustrates in flow chart form acts performed for a database population process;

FIG. 42 illustrates in flow chart form acts performed for an alternative database population process;

FIG. 43 illustrates in flow chart form acts performed for a process to create a recommended referring members list;

FIG. 44 illustrates in flow chart form acts performed for a process for displaying commissions details and requesting payment of commissions;

FIG. 45 illustrates in flow chart form a process for automatic commissions;

FIG. 46 illustrates in flow charm form an alternative commission payout process for paying members;

FIG. 47 illustrates in flow chart form a process for following referring members setup;

FIG. 48 illustrates a process for determining contents to display upon login;

FIG. 49 illustrates in flow chart form a process for a referring members rating process; and

FIG. 50 illustrates in flow chart form a members promoting and advertising process.

### DETAILED DESCRIPTION OF THE PREFERRED EMBODIMENTS

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Files, as referred to herein, generally are digital assets such as documents, emails, photographs, videos, audio files, and the like, which are capable of being stored digitally and reproduced on remote devices when disseminated across a computer network.

User devices, as referred to herein, generally are computing devices that communicate with a data processor, such as a server, across a computer network. User devices may be client devices such as any computing device capable of receiving and sending file sharing information over an electronic network. Such user devices may include personal computers, multiprocessor systems, microprocessor-based or programmable consumer electronics. Examples include desktop computers, laptop computers, tabular computers, notebook computers, cell phones, smart phones, display pagers, handheld or other wearable devices and the like. User devices may be web-enabled client devices that can communicate over the web and include a browser application that is configured to receive and transmit web pages, web messages and other web information. The browser application may be configured to send, receive and display text, graphics, and multimedia by means of a network protocol such as but not limited to Hypertext Transfer Protocol (HTTP) and/or wireless application protocol (WAP).

Goods and Services are for example but not limited to Auctions, Audio (music online radio, tutorials, etc.), Blogging & Ezine, Books & Magazines, Education, Coaching/Training, Fundraising, Gaming, Group Discount Coupons, Internet Marketing, Mobile, Movies & Theaters, Online Dating, Online Shopping, Restaurants, Social Networking, Travel, VOIP, Video (DVD movies, tutorials, etc.), General Public & Social Networkers. Furthermore, other “Services” are for example but not limited to funding raising for non-profits, awareness campaigns, and social awareness campaigns. Awareness campaigns can be for example but not limited to campaigns to raise awareness of a particular cause, such as a disease or condition, campaigns for raising awareness of clubs, groups, topics, teams, societies, such as for example campaigns for but not limited to students from a particular college or university, group of school children from particular county etc.

Specific reference to components, process steps, and other elements are not intended to be limiting. Further, it is understood that like parts bear the same reference numerals, when referring to alternate figures. It will be further noted that the figures are schematic and provided for guidance to the skilled reader and are not necessarily drawn to scale. Rather, the various drawing scales, aspect ratios, and numbers of components shown in the figures may be purposely distorted to make certain features or relationships easier to understand.

Reference will now be made to the drawings in which the various elements of embodiments will be given numerical designations and in which embodiments will be discussed so as to enable one skilled in the art to make and use the invention.

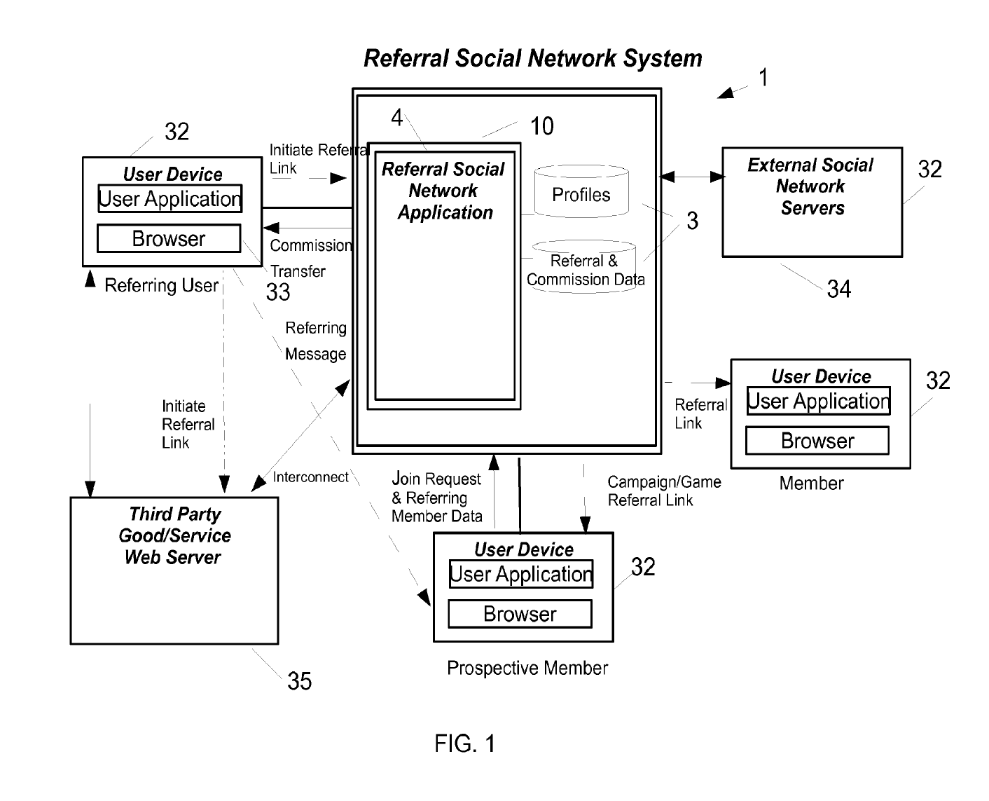

FIG. 1 illustrates a generalized block diagram of an embodiment of a referral social network system provided by a social network that maintains referral and commission tools for monetizing the referral social network. Online referral social network computer system 1 is configured to incentivize personal members of the referral social network to refer other individuals to promote, recommend and/or consume goods and services by offering to pay a referral commission to a referring member for causing others to join the social network and promote, recommend and/or consume goods and services. Members of the referral social network can monetize their own personal referrals and, in doing so, expand their referral social network monetization potential. The goods and services can be promoted, recommended, referred and/or offered by the referring member or a third party provider. The referral social network system includes a server or other processor system 10, a referral social network software application 4 and one or more databases or other data storage or memory devices 3. Referral social network application 4 is configured to enable a user to interact, via a user device 32, with the referral social network system and is for example accessible to the user device by means of a browser 33 or other module. The databases 3 store member profiles, referral relationships and commission models. As will be explained in more detail below, referral social network system 1 is further configured to interact with one or more third party external social network servers 34 and one or more third party external good/service servers 35.

The social network has a plurality of user accounts and one or more administrator accounts. The user accounts are characterized as personal individual user accounts, rather than an owner-operator account of the referral social network. User accounts maintain personal profiles of the users referred to herein as member profiles on the referral social network. The administrator accounts are accounts for owner-operators or others that have been given owner-operator access. The online referral network may also be configured to enable commercial users to promote or advertise products and/or services to users referred to herein as members. Commercial user accounts may be provided on the system to allow commercial users to generate social referral campaigns for promotion or advertising of their products.

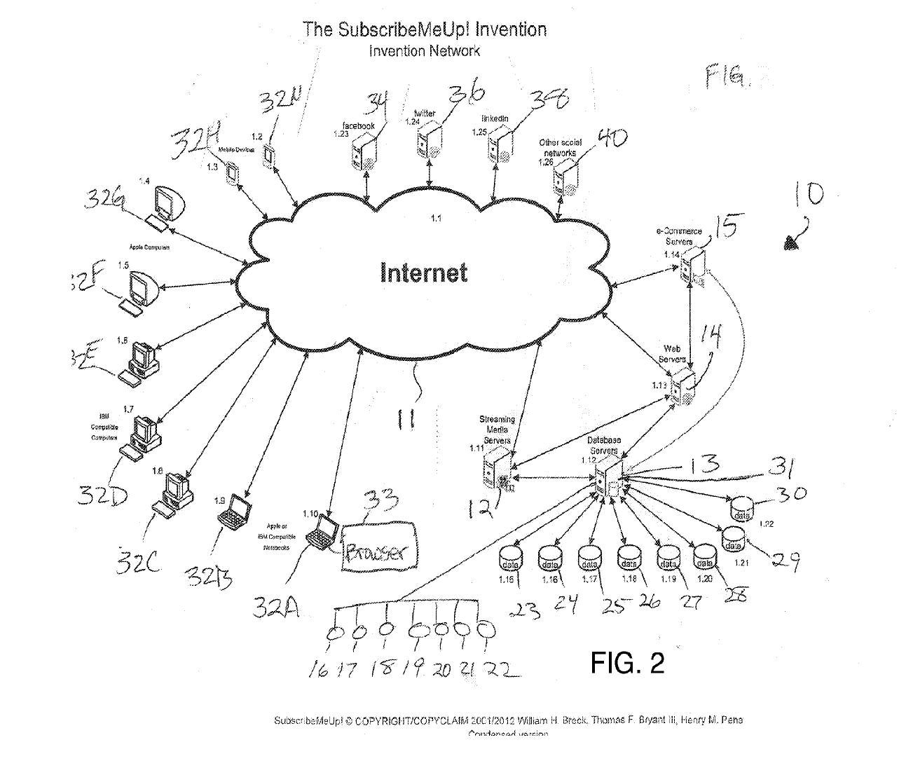

Online referral social network computer system 1 can be implemented in a variety of different network environments. One non-limiting example of specific internet network implementation of the referral social network system 1 of FIG. 1 is shown in detail in FIG. 2. Server system 10 refers broadly to configurations of equipment that, as a system, function to collect data from users and to distribute information to users. In an embodiment, server system 10 may include multiple servers, each of which has functionality that is well-known by those skilled in the art. For example, servers 12, 13, 14 and 15 are servers having memories, processors, communication interfaces and the like, operating as server system 10. Server 12 is a streaming media server. Database server 13 is a database server that manages databases 16-31. In an embodiment, database server 13 manages a centralized database system organized as separate databases having specialized functions. Database server 13 is also contemplated as encompassing a broad, encompassing database system, which may be centralized as described above or a distributed database system. While these components are drawn as separate databases, it is to be understood that they be either separate database systems, or simply discrete data views constructed within a single database system. As shown, database server 13 may include user database 16, platforms database 17, upline database 18, downline database 19, subscriptions database 20, referral database 21, referring members database 22, advertising database 23, commissions database 24, payments database 25, secondary commissions database 26, gaming database 27, autopay database 28, eCommerce database 29 and social metrics database 30. In an embodiment, database 31 implements servers 16-28 as a single database, wherein the views are generated and stored as would be present on separate database systems 16-30.

Web server 14 is a web server that controls communication with user devices and equipment over Internet 11. eCommerce Server 15 is an e-Commerce server that handles financial transactions between parties, such as described here with customers for server system 10. eCommerce server 15 is, in an embodiment, essentially an accounting server, which handles business transactions and payment transactions. eCommerce server 15 utilizes eCommerce database 29 for storage of related data and performing searching functions to provide financial analysis to users. User devices and equipment 11 are shown in various configurations in FIG. 2, and while lines are drawn between user devices 32, it is to be understood that there is no requirement of direct, physical links between server system 10 and user devices 32. Typically, communication between server system 10 and user devices 32 is implemented over a computer network utilizing a telecommunications network, such as a public telephone network, in communication with portable devices such as cell phones, smart phones, tablet computers, notebook computers, and the like. Thus, users can be located at geographically diverse locations, such as different cities, states, and countries around the world. In embodiments, browser program 33 (see FIG. 1) is included in the memory and storage of a user device to provide a user interface between the user and internet 11. Also as shown, user devices 32 can be a large number of devices, indicated by user device 32N. As shown, server system 10 and user devices 32 are associated in a traditional client-server relationship. Server system 10 acts as a coordinator of files received from and distributed to user devices 32 that are operated by individual users who form an exclusive group that embodies a social network. User devices 32 may utilize browser 33 to serve as a user interface between the user and various webpages and visual displays. For commercial user's user devices can be computers such as desktop, laptop, workstation or server configurations operated by other entities, such as operating at well-known commercial websites, or simply access points providing Internet connectivity to other user devices. Such websites may be implemented on Facebook server 34, Twitter server 36, LinkedIn server 38, and other social network server 40.

Referring in more detail to the online referral social network system 1 of FIG. 1, the system has a software system including referral online social network application module 4 which can be stored in system storage/memory for execution by one or more processors to perform the methods for monetizing the referral social networks and other methods of the embodiments described herein. The software system can include a kernel or operating system and a shell or interface. One or more application programs or modules, such as the social network application module 4, may be “loaded” (i.e. transferred from storage into memory for execution by the processor). The system receives user commands and data through user interface; these inputs may then be acted upon by the processor, in accordance with instructions from operating module and/or application module.

One or more processors executing the referral social network application module 4 can in one non-limiting example be a network server site connectable within a network which is the Internet, but equally can be any one of, combination of, or interconnection of, but not restricted to: a local area network (LAN); a wide area network (WAN): a home network; and a wireless network.

Note that the term “module” as used herein may refer to a collection of routines and data structures that perform a particular task or implements a particular abstract data type. Modules may be composed of two parts: 1) an interface that lists the constants, data types, variables, and routines that can be accessed by other modules or routines and 2) an implementation that is typically private, accessible only to that module, and includes source code that actually implements the routines in the module. The term “module” may also simply refer to an application, such as a computer program design, to assist in the performance of a specific task. In other examples, at least part of the modules may be implemented by hard-wired logic or other circuitry.

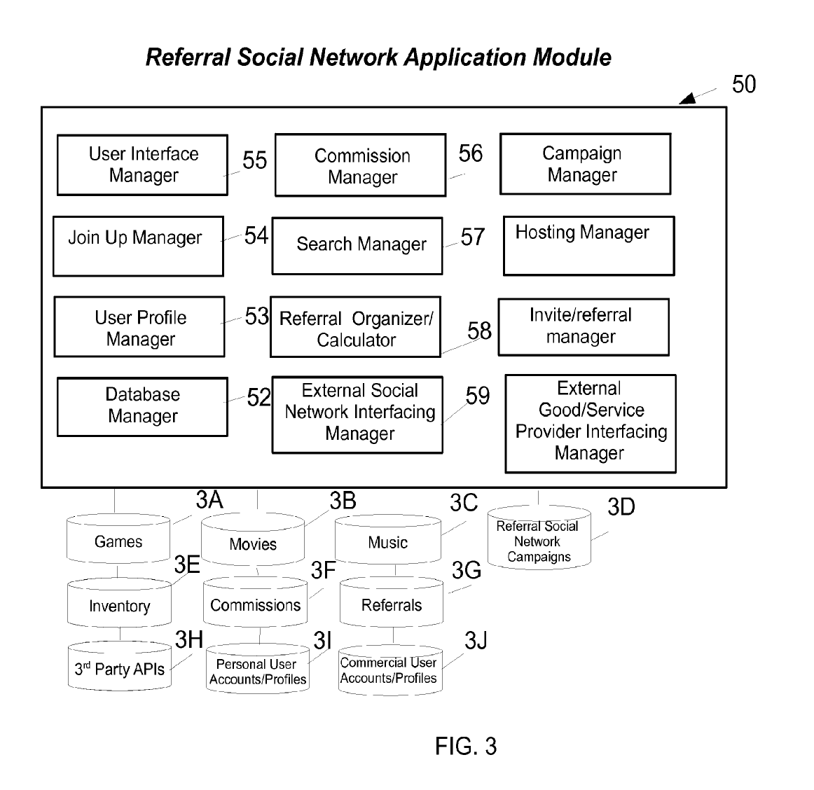

Referring in more detail to the referral social network application 4, FIG. 3, depicts the general major functional modules 50 according to one embodiment that make up the logical structure of the referral social network application software 4. Modules 50 are a user interface manager 55, join up manager 54, user profile manager 53, database manager 52, commission manager 56, search manager 57, referral organizer 58, external social network interfacing manager 59, social campaign manager 60, hosting manager 61, invite referral/manager 62, and external good/service provider network interfacing manager 63. Databases 3 are games database 3A, movies database 3B, music database 3C, referral social network campaigns database 3D, inventory database 3E, commissions 3F, referrals database 3G, 3^{rd} party API integration database 3H, personal user accounts/profiles database 3I, and commercial user accounts/profiles 3J. Database games, movies, music, and other goods/services may be hosted by the social network and/or by a 3^{rd} party. User interface manager 55 is configured to generate and provide various graphical user interfaces of the referral social network for viewing and manipulation by a user on user devices 32. Join up manager 54 is configured to manage join up invites and join up requests. User profile manager 53 is configured to manage user profiles of existing members of the referral social network and of prospective members joining up to the social network. Database manager 52 is configured to manage storing and access of referral social network data stored in the databases 3A-3J. Commission manager 56 is configured to manage commission calculation and payment processes to and from members. Referral Organizer 59 is configured to determine and organize referral relationships between users. External social network interfacing manager is configured to utilize the 3^{rd} party API integration database 3K to manage interfacing between the referral social network application 4 and software applications of one or more other external social networks. Campaign manager 60 is configured to manage generation and display of social campaigns for promoting the social referral network itself, goods and services recommended, referred and/or offered by members and by 3^{rd} parties. Hosting manager is configured to manage hosting of various games, movies, music and other online goods and services for referral by users to other members and prospective members. Invite/referral manager 62 is configured to manage generation and sending of invites/referring communications from members and receiving of communications from recipients. External good/service provider network interfacing manager 63 is configured to interconnect the social referral network with a 3^{rd} party online goods and services procurement application.

Other modules (not shown) may be included in software application 4 according to a particular network implementation. By way of non-limiting example, for the internet implementation of FIG. 2, software application 4 according to one embodiment includes a communications manager that manages web server 14 and a payments module that manages eCommerce server 15 and assists in handling payments to and from members of the referral social network implemented on server system 10. A ratings module can also be provided that is invoked by users who wish to rate member profiles.

Referring now in more detail to user interface module 55 of modules 50 of FIG. 3, in one embodiment, this module is configured to generate a dashboard user interface that is accessible via the user device for enabling a user to interact with the online referral social network application software. The dashboard user interface allows the user to provide instructions via user device 32 to modules 50 to initiate varies processes such as sending referral links to prospective members, generating and posting social campaigns for recommending, promoting and offering for sale goods and services, selecting and authorizing access to the member's external social networks, searching for prospective members according to keyword searches, viewing and manipulating user profiles, viewing commission calculation and payment processes and visualizing organization of referral relationships between users.

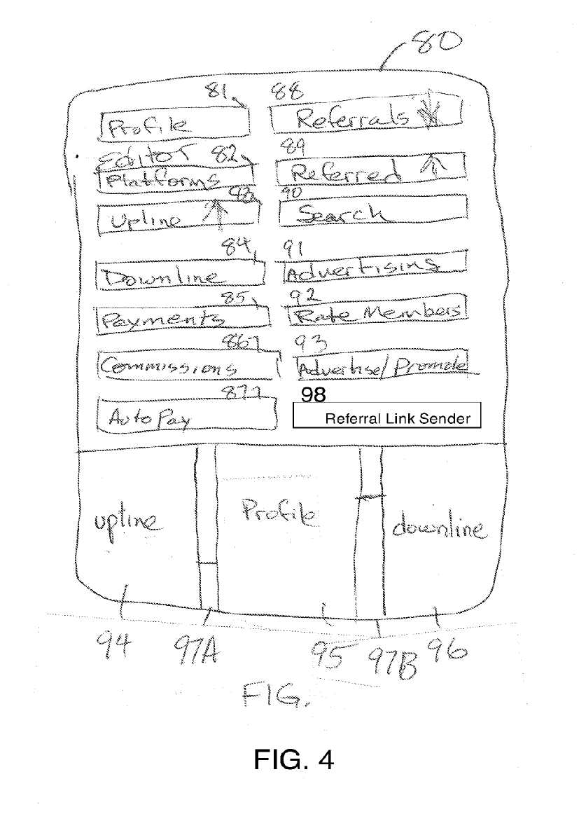

A non-limiting example of such as dashboard user interface for a member according to an embodiment is depicted in FIG. 4. In this example, dashboard user interface 80 is managed by user interface manger 55 and accessible by the member through user device 32. Dashboard user interface 80 has a plurality of buttons or icons that are selectable on the user interface by the member to instruct the software application modules 50 to perform particular processes. By way of one non-limiting example, dashboard user interface 80 has the following user operable control buttons or icons for enabling the member to operate the software application modules 50: referral link sender 98 for generating and sending to users referral links referring prospective members to the social network and alternatively or additionally referring members and prospective members to goods and services being offered online; profile editor 81 for managing and editing the user profile of the member's user profile, platform 82 for selecting a member's external social network account and authorizing access to user connections and information therein, upline viewer 83 for viewing referral relationships upline from the member, downline viewer 84 for viewing referral relationships downline from the member, payments 85 for viewing and controlling payments to the member, commissions 86 for viewing commissions paid, calculating commissions based on referral information and commissions earnable for referring to a member's followers/connections, autopay 87 for setting up auto payments to the member, referrals 88 for viewing user profile information of particular members downline from the member, referred 89 for viewing user profile information of particular members upline, search 90 for initiating keyword search queries, advertising 91 for viewing and generating social referral campaigns for advertising, recommending and promoting the referral social network itself and goods and services being offered for sale through the referral social network, rate members 92 for rating particular members in the social network, and advertiser/promoter 93 for recommending and promoting non-profits and awareness campaigns, advertising and promoting a product etc. A lower portion of dashboard is configured to show upline image 94, member profile 95, and downline image 96.

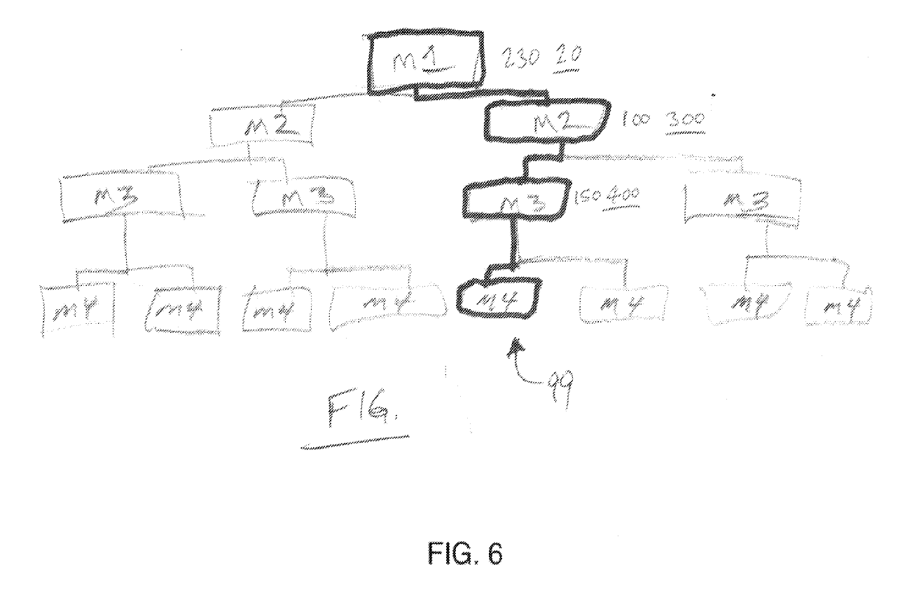

Referring now in more detail to the lower portion of dashboard 80, as outlined above, the lower portion shows upline image 94, member profile 95, and downline image 96 for the member operating the dashboard or for another member selected by the member operating the dashboard profile editor 81. A member's upline image 94 indicates where within the online referral social network a member fits in with respect to other members who have referred the member to the social network, or, in the case of commercial users, to a product or service. An exemplary upline image 94 is an organizational chart referred herein as an “org chart” and an example of which is shown in FIG. 6. Similarly, downline image 96 indicates where within the online referral social network a member fits in with respect to other members referred by the member. Similarly, image 96 can be another organization chart. In other embodiments, the entire display of dashboard 80 can be dedicated for these items, as would be useful for quickly viewing a plurality of member profiles as would be returned upon executing a database search based on keywords or other search criteria (surfing mode).

In an embodiment, volume indicators 97A 97B can be included in the dashboard for example as shown in the lower section of dashboard 80 of FIG. 4, to show quickly the size of the member's upline personal referral network or downline personal referral network, which are depicted as upline image 94 or downline image 96, respectively. Volume indicators can be simple bar graphs displayed vertically, with a smaller volume shown as volume indicator 97A, indicating that upline image 94 is a small network of personal contacts. Volume indicator 97B is configured to show a higher mark, indicating that the member's downline personal referral network is a larger number of members than make up the member's upline personal referral network.

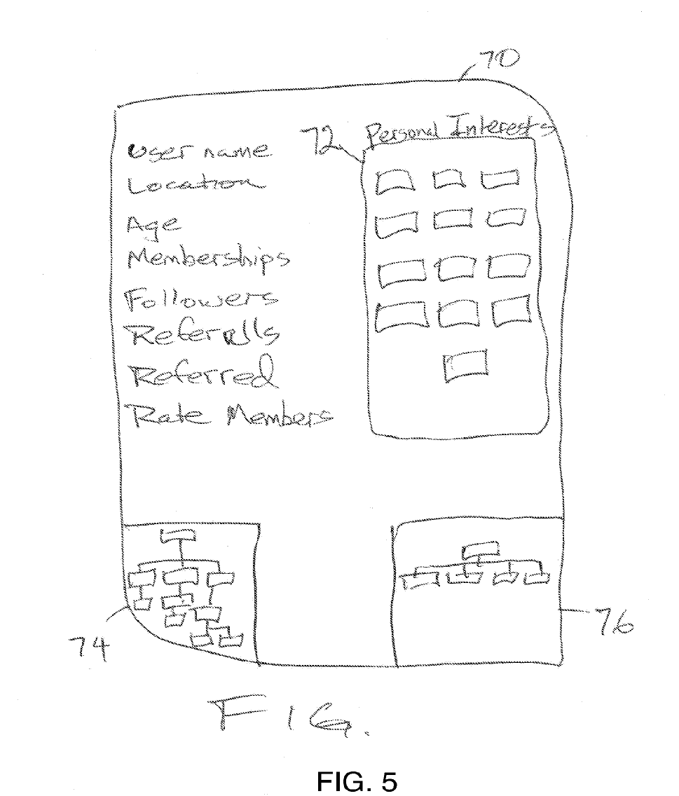

An exemplary member profile of the referral social network system 1 according to one embodiment is shown in FIG. 5. Member profile 70 may be for example shown in dashboard 80 in full or collapsed view or accessible via the dashboard. Included in member profile 70 is information describing an individual member of the referral social network implemented on server system 10. Information gathered during a member's signup process includes items such as name, location, age, memberships, and similar information for social networks, but also a categories of personal interest section 72, which may include one or more topics of interest selected by the member, such for example upon signup. Member profile 70 can also include upline image 74 and downline image 76 showing referral relationships for the specific member associated with the user profile.

Search parameters may be included in the user profile with selections of categories of personal interest 72, such as age, location, gender, memberships, number of followers, number of referrals, number of times the member has successfully been referred, or other suitable information contained within a member profile 70 or elsewhere.

Reference will now be made in more detail to upline and downline images for example as shown in dashboard 80 and user profile 70. Upline image 74,94 show an upline chain of referrers beginning with the member who referred the member to the online referral social network, if one exists, and, in an embodiment, continues for example vertically from the member who referred the member to his or her referral, on up to a predetermined or desired number of levels. In an embodiment where the member is one of a plurality of referred members by another member, upline image can be a tree structure showing relationships between members of the online referral social network. Downline image 76, 96 is an image of a chain of downline referrals for a desired number of levels. In an embodiment where a member has referred multiple members, the downline image 76, 96 can be tree structure of the downline relationships between the member and subsequent referred members can be displayed to the member. Profile 95 shows the member profile information for the member accessing the dashboard 80.

Upline image 74, 94 are beneficial for use in rating the quality of referrals through a rating process, where members can rate members of their personal contact list shown in whose referrals have been relied upon by the member, and thus the member can rate the experience either by number, expressing a like or dislike, or generating a written commentary, or selecting expressive icons that convey a member's feeling, good or bad, about the referral.

FIG. 6 illustrates an exemplary org chart 99, which shows relationships between individual members who have member profiles on the online referral social network. An org chart 99 showing upline referrals is one way to show upline image 74,94. An org chart 99 showing downline referrals is one way to show downline image 76,94. For example, on FIG. 6, this is shown where member m1 is located in relation to m4. The number of relationships separating one member and another can have degrees of separation beyond a simple direct relation.

In one embodiment, the upline and/or downline referral images generated by the system and viewable on the dashboard or other user interface can include information about referrals made by each member through the social referral network to online goods and services being offered for payment or paid for by referees. By way of example, the upline image, in addition to showing relationships between individual members can additional show a goods and services referral number adjacent the member's node in the referral chain, the number indicating the amount of referrals made to online goods and services through the social referral network. In another example, the upline image can show total number of referrals made by each member to the referral social network and this total number for each member can be shown adjacent the member node represent the member in addition to or as an alternative to the goods and services referral number. For example, in the organizational chart of FIG. 6, member m1 has directly referred 230 users that have joined the referral social network and has referred through the referral social network 20 online goods and services to users that have been viewed/consumed by users. In yet another embodiment, a member can use dashboard 80 to select through a keyword search or otherwise a particular interest or interest category associated with member profiles and, in response, the online goods and service referral numbers in the upline and downline images adjacent each member node can be updated to show the number of referrals made to goods and services in the particular interest category and/or highlight the members in the upline image having similar interests.

By indicating on the user interface upline image referral numbers for each member in the upline chain in respect of referrals made to the referral social network, goods and services offered online and filtered for particular selected interests, a member can visualize referral behaviour of the member in comparison to others in the upline referral image. This may be useful for targeting new social campaigns to particular members and also for analyzing the “referral quality” of the referral network.

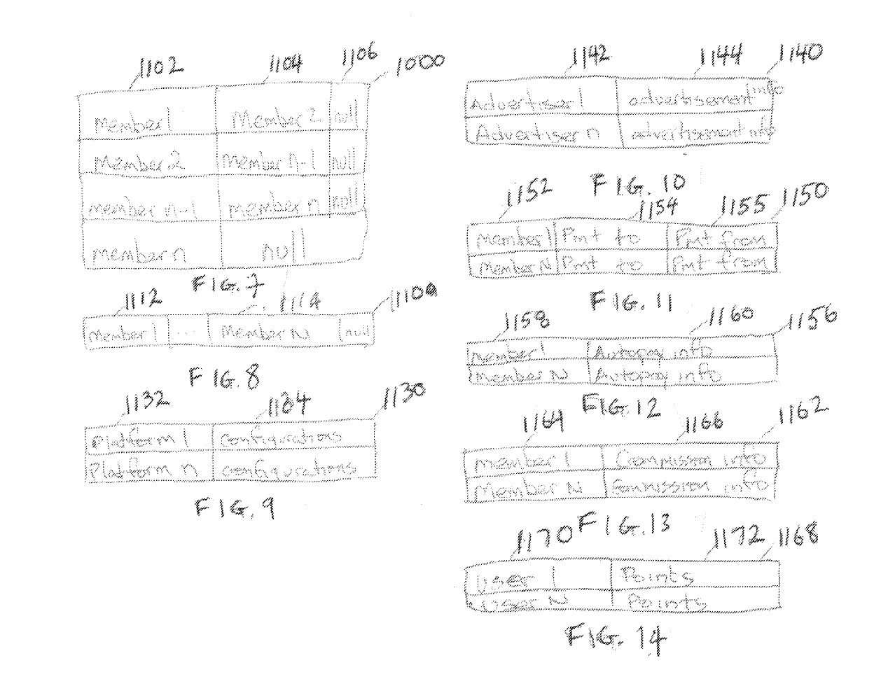

Referral chains, such as Org charts 99 or other organization structures as referred to in the above methods can be generated from data base records of the social network system 1. In one embodiment, exemplary database records for an implementation of org chart 99 having number of members n in either an upline or downline relationship, records 1000 include a first field 1102, a second field 1104, and a null field 1106 as shown in FIG. 7. As an example, this organization can indicate a referral relationship. For example, member 1, in field 1102, is the referrer of member 2 in field 1104. In the next record, member 2 is the referrer of member n−1. In the final record, there is only member n, who has yet to refer anyone. This record reflects this status by placing a null value in field 1104. Org chart 99 can be constructed from records 1100 by traversing records 1000, beginning at the bottom, where the null value is detected in field 1104, and placing member n at the bottom of org chart 99, and working upward to construct a tree such as shown in org chart 99. For members having referred multiple members, record 1100, shown in FIG. 8, illustrates field 1112 as the referrer, and multiple members in fields 1114. By traversing record 1100, this list of multiple-referring members can be constructed in the tree relationship shown in org chart 99. It is to be understood that the same organization shown in records 1100, 1110 can be applied to other databases in server system 10. Similarly, multiple platforms from which users are allowed to log in to server system 10, such as external social network platforms 34-40 shown in FIG. 2, can be supported in platforms database 22 by storing specific platform configurations in record 1130 (FIG. 9), each individual external platform supported by server system 10 can be identified in field 1132 and associated with its specific configuration information in field 1134.

Other records of the system 1 may for example include records of advertisers. Advertisers can also be organized as shown in the database of FIG. 10 in record 1140, with advertisers identified in field 1142 and associated with their individual advertisement or other information in field 1144. Payments for members can be implemented through record 1150 (FIG. 11), with members identified in field 1152, payments disbursed to members in field 1154, and payments received from members in field 1155. Record 1150 can be used for other users of server system 10 as well as members, such as advertisers or commercial users. Autopay referral compensation amounts for referring members can be implemented by record 1156 shown in FIG. 12, having field 1158 to identify the member and field 1160 to show the autopay amount requested by the member. Commissions earned by members for referring new members can stored in record 1162 in FIG. 13 in fields 1164 identifying members and fields 1166 identifying corresponding amounts.

Gaming points, or another secondary commission or bonus paid to members, can likewise be organized in record 168 (FIG. 14) for individual members identified in field 170 and associated with a points value in field 172. The records shown in FIGS. 7-14 are to be considered as illustrative and not exhaustive; other records are discussed below and can be similarly illustrated.

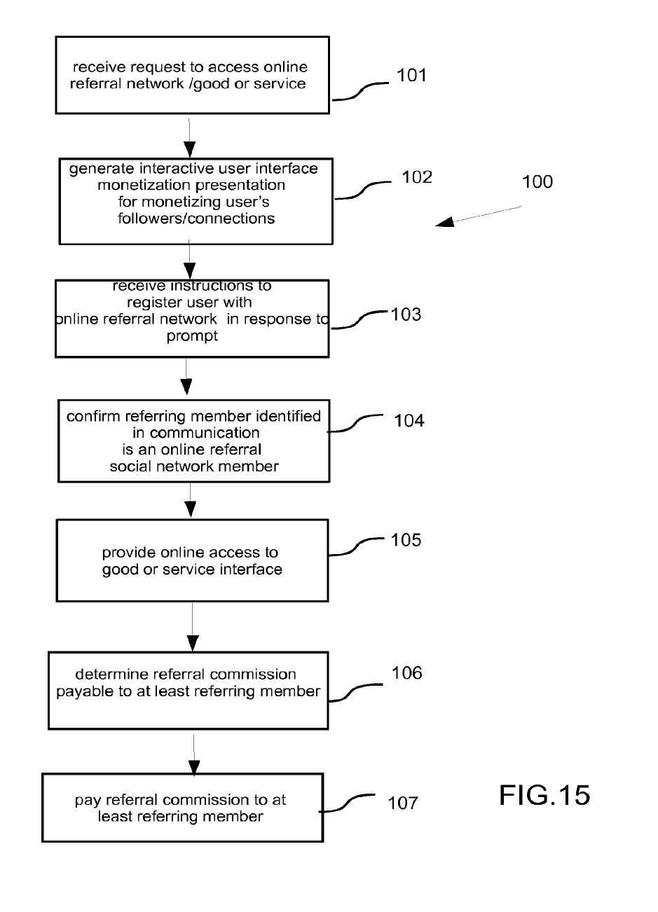

A computer implemented method for monetizing the online referral social network implemented in the referral social network system of FIG. 1 according to one embodiment will now be described. As indicated in the flow chart of FIG. 15 of method 100, the online referral social network system 1 receives over a computer network from a user device 32 one or more communications requesting access to the referral social network and/or one or more goods/services (process 101). System 1 then generates an interactive presentation user interface which is provided over the computer network to the user device of the user (process 102). As will be more adequately explained below with reference to examples, the interactive presentation is a monetization presentation that provides information to the user on how to utilize the referral social network to monetize their follower/connection networks.

User registration instructions entered via the referral social network user interface are received by the system (process 103). The system then confirms a particular online referral social network member indicated in a communication received from the user device as having referred the user to the online referral social network is either non-paying affiliate or a paying member of the online referral social network (process 104). The communication including an indication of a particular member of the online referral social network as having referred the user to the good or service through the online referral social network can be the received communication requesting to procure the online good or service in process 101. In another example, the communication including the referring member indication can be received for example during the process of registering the user as a new member.

The referral social network system then provides the new member with online access through the referral social network to procure any good or service the user may have initially requested in process 101 (process 105). In one example, online access is provided through the referral social network to a good or service application user interface which is provided external from the referral social network, for example by a 3^{rd} party provider. In another example, the good or service is hosted by a 3^{rd} party system but the good or service application user interface is hosted by the referral social network and payment and procurement is processed through the referral social network. In yet another example, the good or service is an online good or service hosted by the referral social network and the online access to good or service user interface for procuring said good or service provided by the referral social network. In the example where a request in made in process 101 is for accessing the social network but not a good/or service, process 105 is redundant.

System 1 then determines a referral commission payable to the referring member and optionally one or more other members upline and/or downline from the referring member (process 106). The referral commission can be determined based on the referring member causing the user to register with the referral social network as a new member. In another example, the referral commission can be determined based on additionally or alternatively the referring member causing the new member to procure the referred good or service.

The system then initiates payment of the referral commission over the computer network to the identified referring member (process 107).

By the online referral social network system sending the referral social network user interface to the user device of the user in response to a request from the user to access the social referral network and/or procure a good or service and determining and paying a referral commission to the referring member for causing the user to register with the social referral network and/or procure the good or service through the referral social network, members of the referral social network can easily monetize their own personal referrals by referring the referral social network and/or goods and services to users. The method incentivizes personal member account holders of the referral social network system to refer other individuals and monetize their own follower/connections.

In one embodiment, method 100 is implemented by modules 50 of software application 4. For example, process 101 is implemented by user interface manager 55 receiving and handling one or more communication requests. The communication(s) can be any communication received over the computer network containing information requesting to procure online a good or service. In one example, the identity of the referring member can be contained in the same communication as a join up request communication. In another example, the identity of the referring member can be contained in a separate communication from the join up request communication. Such communications can be any type of electronic communication received from a user device 32 over the computer network. For example, such communications can be e-mail communications or communications resulting from web activated links that are generated either outside or within the online referral social network environment.

For example, processes 102 and 103 are implemented by the user interface manager 55 in conjunction with join up manager module 54.

For example, process 104 is implemented by user profile manager 53 accessing member profile information contained in member user accounts and join up manager module 54 comparing the referring member identity contained in the communication, or a future communication for example received as part of the subsequent registration process, with member identities contained in the member profile information. If a match between the referring member identity contained in the communication and a member identify in a member profile is found, the join up manager 54 confirms that the referring member identified is an online referral social network member. If a match is not found, the join up manager sends a communication to the user device of the user alerting the user an error in confirming the referring member and requesting that the prospective member re-confirm the referring member's details.

For example, process 105 is implemented by external good/service provider interfacing manager module 63 in conjunction with user interface module 55.

For example, process 106 is implemented by commission manager 56 calculating a referral commission which can be for example based on the referring member referral information stored in the referring members user profile or elsewhere. In one example, the commission manager 56 determines the commission to be paid to the referring member according to upline referrals associated with the referring member. For example, the commission can be determined according to the number of referrals the referring member has already made. In another embodiment, commission manager 56 also pays a commission to the referring member for referring the good/service to the user that registers with the social referral network as a new member. In yet another embodiment, commission manager 56 also pays a commission associated with the referral made by the referring member to other members that already have a referral relationship with the referring member.

For example, commission manager 56 implements process 107 by managing electronic payment of the referral commission to the user. Commission manager 56 can pay the referring member and any other members electronically in different ways. For example, commission manager 56 can instruct an e-commerce server to initiate a funds transfer online from a bank account associated with the online referral social network to the bank account of the identified referring member.

In one embodiment, members or prospective members of the online referral social network are personal individuals, non-commercial use members that have personal, non-commercial use accounts and profiles. These members are neither commercial users, such as suppliers of goods and services, nor are they social network service provider members. In one example, these individuals may be consumers of goods and services but not suppliers of goods and services. The system can determine the identity of the referring member by looking up information in personal non-commercial user profiles of these members according to information in the inquiry or join request received from the user device. In another example, at least some of these members are commercial users with commercial accounts including user profiles. In yet another example, these members are made up of a combination of both the personal individual members and commercial user members.

In one embodiment, users are either registered members (member user or member or referring member) or unregistered guest users (guest or a guest user). Members generally have more access to content, premium content and functionality than Guest Users. Registered Users have ‘registered’ by providing identification information such as: valid email address, a username and other identifying information. Registered users are either non-paying affiliates (affiliate or Referring Affiliate) or they are a paying member by virtue of making a one-time or by making payments in a recurring subscription.

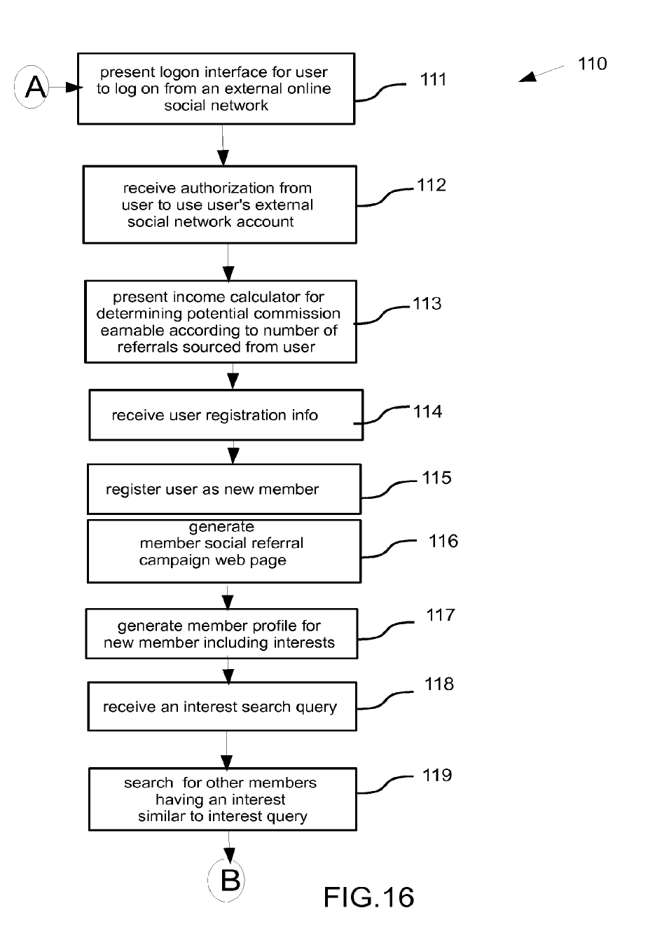

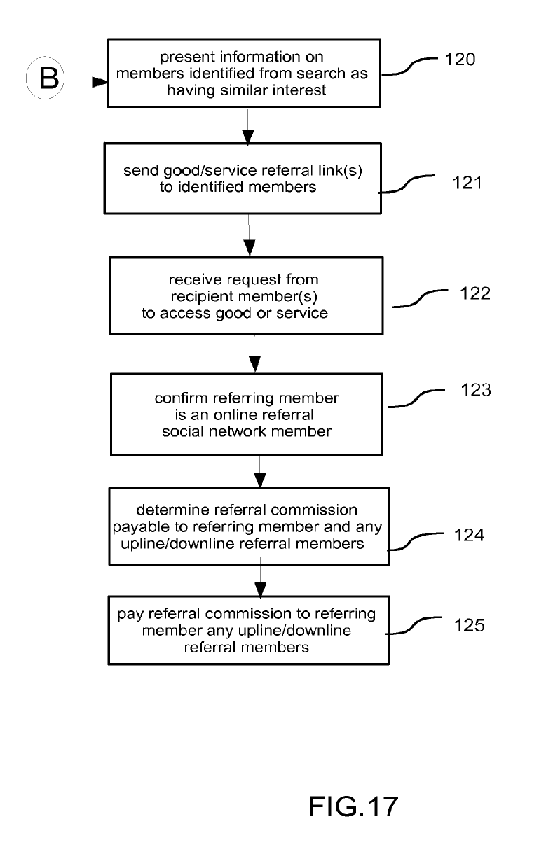

A computer implemented method for monetizing an online referral social network according to another embodiment implemented in the social referral network system 1 will now be described with reference to FIGS. 16 & 17. In this particular example, it is assumed that a user has been referred to the referral social network by a referring member of the referral social network and that the user wishes to join. As indicated in the flow chart 110, referral social network system 1 initially presents over the computer network to a user device a login interface for the user to log on to the system from the user's external social network for the purpose of setting up registration to the referral social network (process 111). Process 111 can be implemented by external social network interfacing manager 59 of software application 4. The user can login using different types of information such as the user's name and/or e-mail address.

Online referral social network system 1 receives authorization over the computer network from the user device of the user for the online referral social network system to access over the computer network and use the user's external social network account (process 112). Process 112 can for example be implemented by external social network interfacing manager 59. Such authorization to use the user's external social network account information can be implemented in different ways. For example, such authorization can be given by a user clicking on an icon. Authorization to use the user's external social network account can for example include authorization to access the user's external social network followers/connections information, access password and messages. The referral social network can use the user's external social network account information in different ways. For example, the referral social network can read posts, messages, timeline information etc. in the user's external social network account, see who the user is following or connected to in the external social network, update the user profile in the external social network account and/or post to, or send messages from, the external social network account.

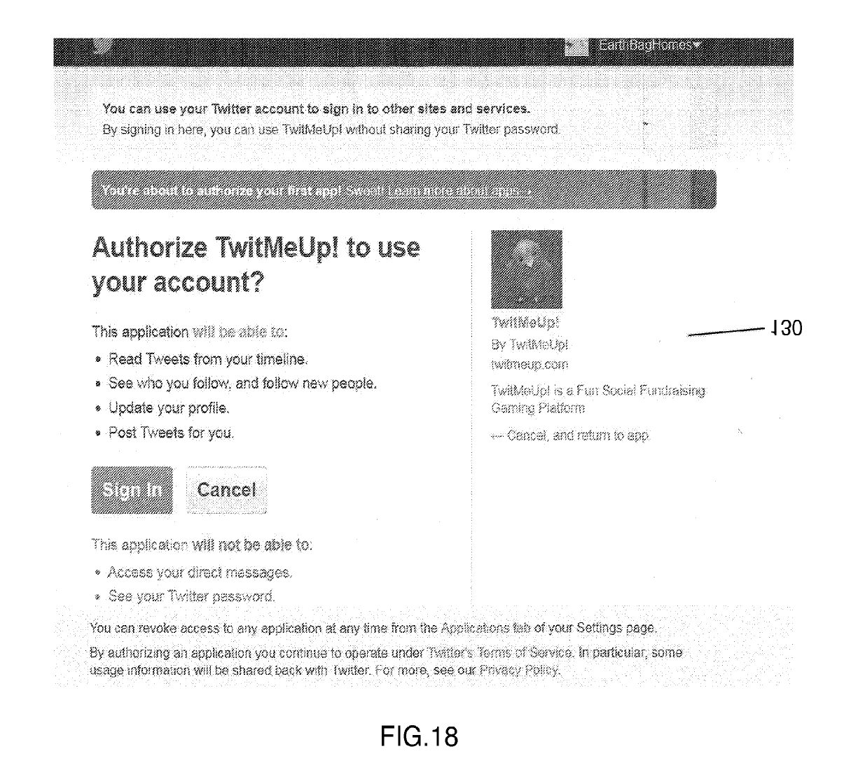

In another embodiment, the system can present the initial login interface for the user to login directly into the referral social network system rather than from their external social network and then once the user has logged in directly to the referral social network present the login interface for logging in to the external social network user. Logging in to the external social network may then automatically authorize the system to use the user's external social network account. One non-limiting example of a login interface for authorizing the system to use the user's external social network account information is depicted in a screen shot 130 of FIG. 18.

By providing such login interfaces, the user of the system is able retrieve information including follower/connection information from separate systems using one interface for making subsequent referrals. Many contacts and connections may now be completed electronically, which reduces redundant data entry and mistakes made by multiple manual inputs.

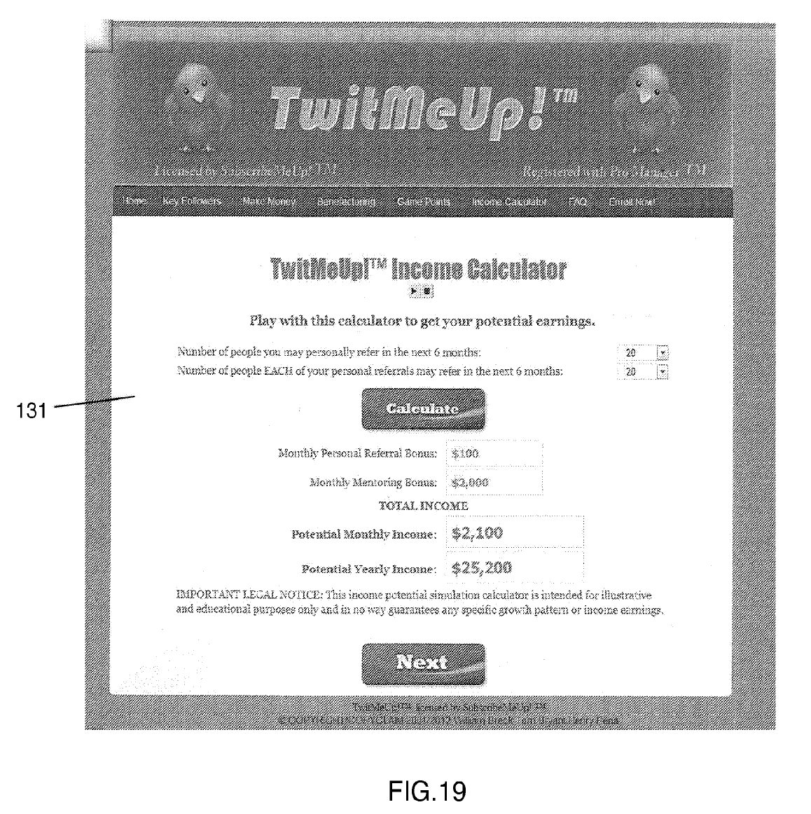

Method 110 continues as shown in FIG. 16 by presenting an income calculator interface to the user device of the user for determining potential commission earnable according to number of referrals sourced from the user (process 113). The income calculator interface receives user instructions from the user about the number of potential referrals the user can source, calculates a potential earnings and presents the calculated earnings on the calculator interface. By providing such a calculator for viewing and manipulating on the user device of the user, a user is incentivized to refer other users to the referral social network system. One non-limiting example of such an income calculator is shown in the screen shot 131 of FIG. 19. Exemplary Income calculator interface calculates potential earnings based on information such as the number of people the user can personally refer over the course of a particular length of time, such as 6 months, and the number of people each of those referrals can refer in that length of time.

As indicated in FIGS. 16, method 110 continues by the system 1 receiving user registration information over the computer network from the user device (process 114). Process 114 may be for example implemented by referring and join up manager 54 in conjunction with user interface module 55 and other modules of the software application 4. In one example, system 1 generates an enrollment form for presenting to the user device and completing by the user. Registration information received by the system 1 can include for example name, e-mail address, user name, password, gender, birthday, affiliate referrer identification , confirmation that the user is human and agreement to terms of service. In one example, receiving user registration process 114 info can include receiving a signup validation link activation communication in response to sending a signup validation link to the e-mail address of the user and the user clicking on the link to validate the identity of the user.

Method 110 continues by system 1 registering the user as a new member of the referral social network (process 115). Process 115 may be implemented by join up manager 54 in conjunction with user interface manager 55 and profile manager 53. The new member may be presented with a login interface for logging in as a member into the referral social network or may be automatically logged on via the signup validation process. Method 110 continues by the system generating a referral campaign webpage for the new member and a webpage link to the new member's referral campaign webpage (process 116).

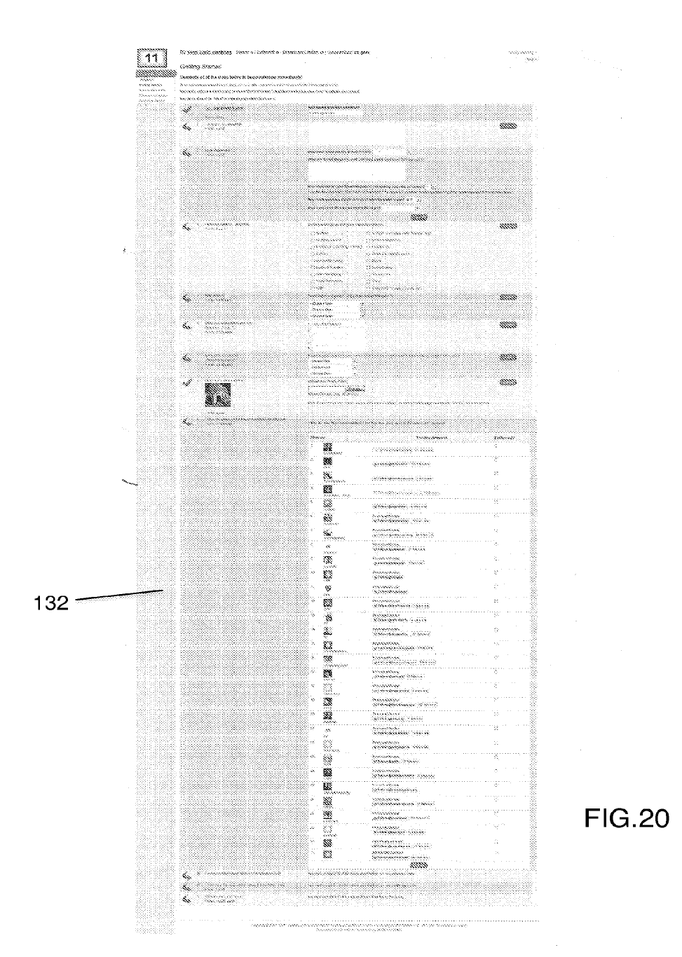

Method 110 continues by system 1 generating a member profile for the new member (process 117). The process 117 can be implemented by for example user manager 54 in conjunction with user interface manager 55 and other modules. In one embodiment, an interactive process is implemented during the join up process or shortly after registration is implemented in which user interface manager renders a user interface screen on the user device requesting user profile information, such as name, age, gender, location, etc. In one example, the generated user interface screen requests information relating to the referring process, such as how much income the user wishes to earn from the referral process, keywords describing personal interests of the member etc. One example of such a user information request interface screen is interface screen 132 shown in FIG. 20. As shown in the screen shot 132, the user interface screen includes requests for “about me” information, i.e. information about the user; the user's referral earnings target; products or things the user wishes to buy or afford; importance of financial priorities; how much the user wishes to donate to a worthy cause, such as but not limited to a non-profit and/or awareness campaign or social campaign, the number of followers the user would like to procure, selection of personal referral categories such as auctions, blogging, education, gaming internet marketing, movies and theaters, online shopping, social network, voip, audio, books and magazines, group discounted coupons, mobile, online dating, restaurants, travel, video etc; selection of kind of groups, clubs, organizations of which the user is a member, user-selected keywords describing a user's personal interests, such as financial freedom; areas or topics that the user desires to have social impact and make the world a better place, profile pictures of the user.

Method 110 includes receiving a personal interest search query for generating a recommended following/referral list for assisting the user in following members in the referral social network and/or referring goods/services/campaigns to other members or (process 118). Process 118 can be implemented by search manager 57 in conjunction with other modules of application 4. In one example, receiving the personal interest search query can include receiving keywords entered into the user information interface screen, such as user interface screen 132 of FIG. 20. In response to receiving the query, method 100 continues by the system searching among other members of the social referral network having interests similar to queried personal interest (process 119). The system then generates information on the other members identified from the search as having similar interests to the user (process 120) to assist the user in following, and/or referring goods/services/campaigns to, other members and/or prospective members. One example of such generated information is a recommend following/referral list, such as for example as depicted in the screen shot of FIG. 20. The recommend following/referral list can, for each member identified in the search, identify the member and include a follower link for linking the user to the external social network of the listed member and following them in their external social network.

By receiving such search queries and searching among member's internally in their internal referral social network account, members can easily target, either personally and/or electronically, such as via the follower links, other members according to specific key word(s), key phrase(s) or key function(s) information for the purpose of expanding their social networking contacts, connections and followers internally and, in turn, externally of the referral social network and making referrals via the social referral network to goods or services provided by the referral social network or 3^{rd} party providers.

In one embodiment, the referral social network can, through user interaction with the user interface recommended following/referral list, track which members from the list the user has selected to follow in their external social network. This tracking can be achieved for example by the system tracking a user selected tick on a box on the user interface next to the listed member that the user is to follow via the follower link. Alternatively or additionally, this tracking process can be implemented, in response to the user selecting one of the follower links in the list, by the referral social network automatically directing the user device of the user to a tracking link, the tracking link automatically capturing the user interface entered selection to follow a listed member via the follower link to the external social network, and the referral social network then redirecting the user device to the external social network site for following the member in their external social network. The referral social network can reward a member with redeemable points, such as game points etc., according to the tracked followers.

In one example, the recommend list can include the identified member's external social network follower/connection numbers or other information enabling the user to quickly identity the size/quality of the listed member's own personal social network(s) and therefore the referring potential of the listed member. Furthermore, in another example, the recommended list on the user interface can include, for each listed member, a contacts link in the list for linking the user to the personal contacts/e-mail lists of the member for making further referrals. In one example, the personal contacts/e-mail lists can be obtained by the social referral network from the listed member's external social network account information upon authorization by the listed member (for example on registering with the referral social network.

In another example of process 119, 120, in response to receiving the query, the process continues by the system searching among follower/connection information for followers/connections in the user's external social network account having interests similar to queried personal interest. The system then generates information on followers/connections identified from the search as having similar interests to the user for following and/or referring to the referral social network by the member. The referral social network may for example search among public profiles of a listed member's external social network followers/connections to determine which of the listed member's external social network followers/connections have similar interests to the user.

Processes 111-121 of method 100 are one example of the process step 102 of generating an interactive monetization user interface (see FIG. 15) which allows the user to learn how to utilize the referral social network to monetize their own online followers and connections.

Method 110 continues by system 1 sending over the computer network one or more referral links to members in the recommended in the list or other members (process 121). Process 121 can be implemented by for example module referring and join up manager 54 in conjunction with other modules of application 4. In one embodiment, process 121 can be implemented automatically without further interaction with system 1 by the member. The referral links can be sent to the users in different ways. In one example, the referral links can be sent internally within the referral social network. In another example, the referral links can be sent to the e-mail addresses of the members. In another example, the referral links can be sent to the external social network accounts of the referral social network members. The system incorporates an identifier in the referral links identifying the referring member. In one example, the identifier can be embedded and hidden from the user viewing the received referral link on their user device. In another example, the identifier can be included in the referral link and visible to the user viewing the received referral link. In another example, referral link can include a referral to one or more online goods and service 3^{rd} party websites or goods and services hosted on the referral social network. In one example the referral link can be customized to include particular goods and/or service referrals via the user interface of the social referral network by the member prior to the system 1 sending the link to the follower(s)/connection(s). In yet another example, the referral link can be a website link to a referral campaign webpage/feed of the new member and generated by the system. The webpage/feed link can be customized for use with a particular external social network. The referral campaign webpage can be customized by the new member to include referrals to goods/services provided by the new member and/or 3^{rd} parties. The member(s) receive over the computer network the referral links on their user devices.

Method 110 continues by system 1 receiving over the computer network from a user device of a recipient of the referral link a request in the referral social network to access any goods and/or services online (process 122). The goods/services request can be any type of electronic communication received from over the computer network from a user device. For example, the request can be an electronic message automatically generated in response to the recipient activating the referral link. In another example, system 1 receives a good/services request in the form of an e-mail from the recipient. In another embodiment, the system 1 receives a good/services request via a user interface of the referral social network that is presented on the user device and requests for example user information so that the user can request the good/service being referred.

Method 110 continues by system 1 confirming the referring member identified is an online referral social network member (process 123). The system can receive the name or identifier of the referring member during the referral process in different ways. For example, when a referral link sent by the system to the recipient includes the identifier of the referring member, the system can receive a referral ink activation message including the identifier and then compare this identifier to identifiers of members in the referral social network to determine if the referring member is a member of the referral social network. In another example, system 1.

Method 110 then continues by system 1 determining the referral commission payable to the referring member (process 124). In one embodiment, the system 1 determines the commission to be paid to the referring member according to the upline and/or downline referrals associated with the referring member. For example, the commission can be determined according to the number of referrals the referring member has already made. In yet another embodiment, the system 1 determines the referral commission payable to other members that already have a referral relationship with the referring member so that a total referral commission can be distributed among the referring member and other members having a referral relationship with the referring member. In other embodiments, the commission can be determined according to one or more of the embodiments using a one call database as will be explained in more detail below.

Method 110 continues by the system paying the referral commission to at least the particular identified referring member (process 125). Commission manager can do this for example by obtaining payment details from the referring members profile and handling electronic payment of the calculated referral commission to the referring member's account.

In other embodiments, method 110 is not limited to the sequence of processes shown in FIGS. 16 & 17. By way of example, receiving user registration info (process 114) and/or registering user as a new member (process 115) can be implemented before for example process 111, 112, or 113 or later in method 110. Presenting income calculator (process 113) can be omitted or implemented before process 111, 112 or 113 or later in method 110. Processes 116-120 can for example be omitted. In other embodiments, processes of method 110 can be implemented by current members of the referral social network, where appropriate, as an alternative or in addition to new users in the registration process. For example, processes relating to accessing and authorizing use of external social network accounts (process 111 & 112), receiving interest queries (process 118), searching for other members(process 119), presenting members identified from searching (process 120) and other processes 121 to 125 can be implemented for current members wishing to receive further compensation by referring other members to goods/services other users to register with the network.

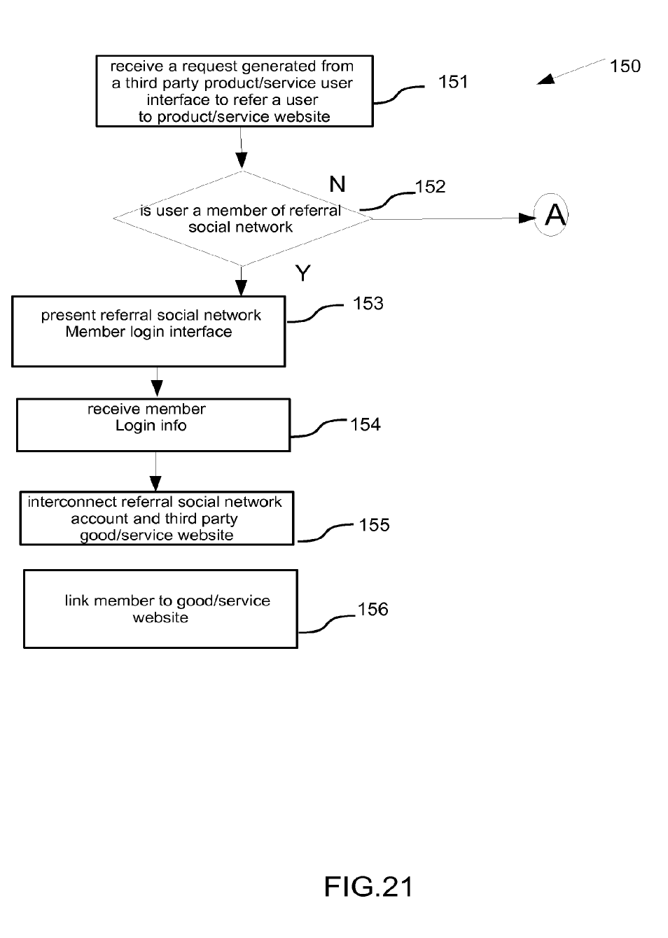

A computer implemented method for monetizing an online referral social network according to another embodiment implemented in the social referral network system 1 will now be described with reference to FIG. 21. In method 150, the system receives a request generated from a third party online good or service user interface to refer a user to the online good or service (process 151). System 1 then determines from received instructions if the user is a member of the referral social network or not. If the user is not a member, the process proceeds to the generating monetization user interface (process goes to for example processes 111 to 120 in FIGS. 16 & 17). If the system determines the user is a member of the social referral network, the system 1 presents to the user device the member login interface (process 153) and, in response, receives member login info (process 154) as a result of the user entering the login info. The system then interconnects the referral social network account and third party good/service website (process 155). System then links the user through the referral social network to the good/service website identified from the request in process 151 (process 157). This can be implemented for example automatically or be sending an activation link to the user for linking to the good/sevice website.

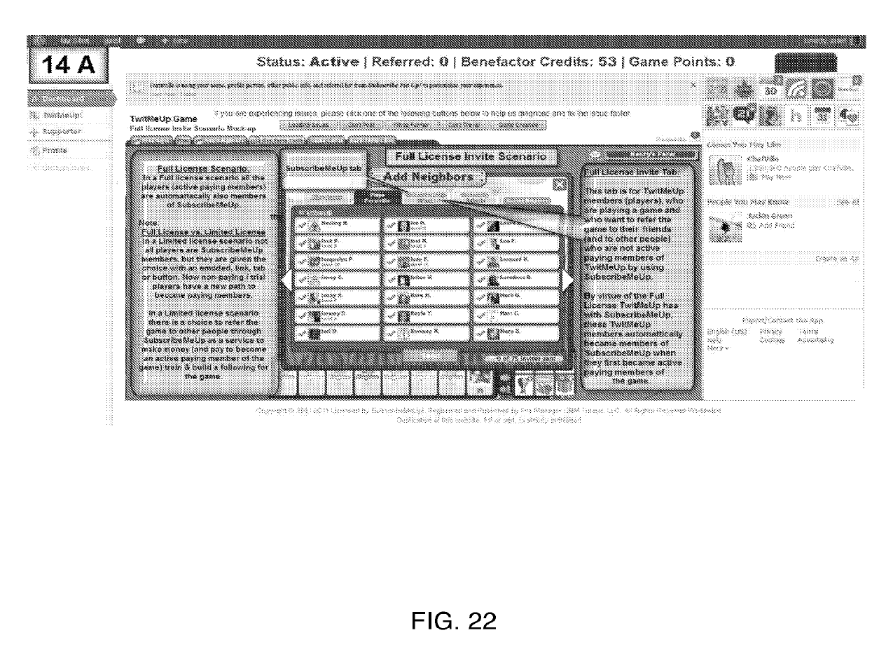

Some non-limiting examples of method 150 and other methods of how the referral social network operates with 3^{rd} party good/service provider websites will now be described. In a Full license Invite scenario all the active paying members of the fully licensed company, non-profit, individual, etc. (licensee) are automatically members of the social referral network. FIG. 22 is a screen shot showing an exemplary 3^{rd} party game user interface in which process 151 is implemented in response to a user clicking on a tab identifying the social referral network. In this manner, members of the referral social network that are playing the 3^{rd} party game who want to refer the game to their friends or other users can click on the referral tab and invite their friends/users. When the invited friends/users become paying members of the game in response to receiving the invites, the friends/users automatically become members of the social referral network as well.

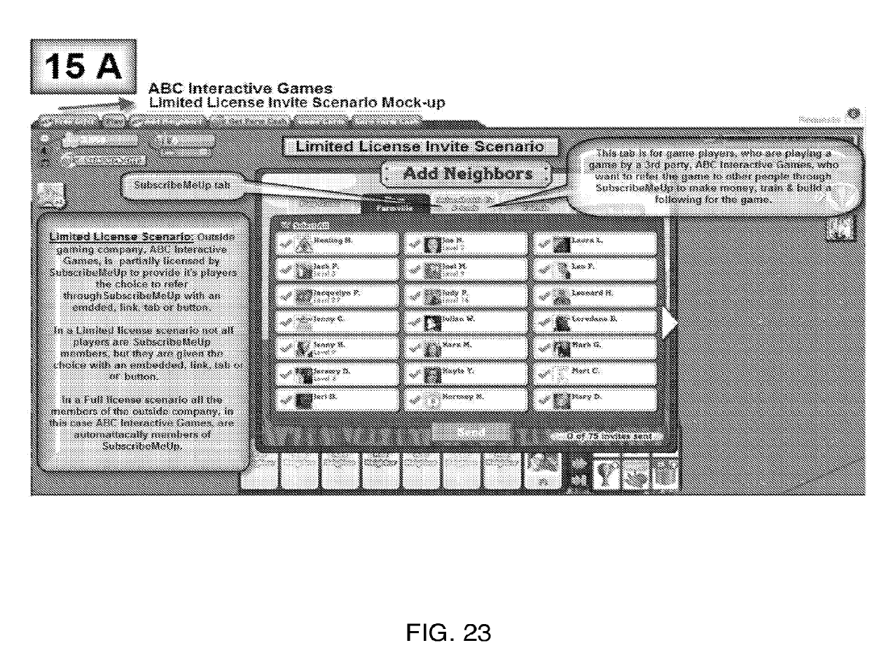

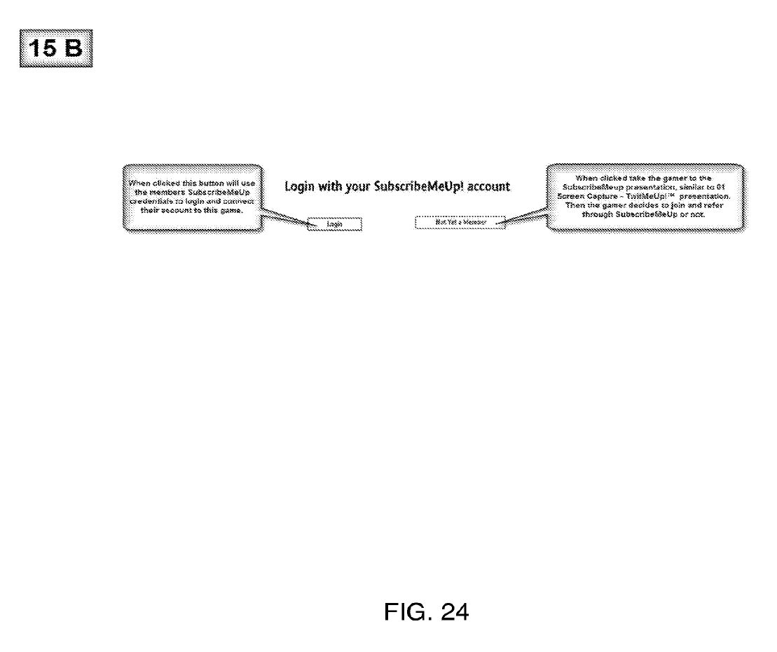

In a Limited license scenario not all members of the limited licensed company are social referral network members. Instead members of the limited licensed company system are given the choice with an embedded link, tab or button on the limited licensed company user interface that takes them to the monetization presentation describing the benefits of using the social referral network. One example of a screen shot of such a limited licensed company user interface is a game user interface as for example shown in FIG. 23. FIG. 24 is an example of a login user interface of the referral social network that is generated and presented to the user device upon the user activating the embedded link, tab or button.

In a Limited license scenario there is a choice to refer the game, service, product, etc to other people through the referral social network as a service to make money (and pay to become an active paying member of the game, service, product, etc) and train & build a following for the game, service, product, etc. Now non-paying/non-premium/trial members of the limited licensed company can make money and have a new path to become paying/premium members. Now licensed companies, non-profits and individuals have a way to have members to promote their games, services, products, and make a new additional stream of income from profit sharing derived from entering into licensing with the social referral network invention.

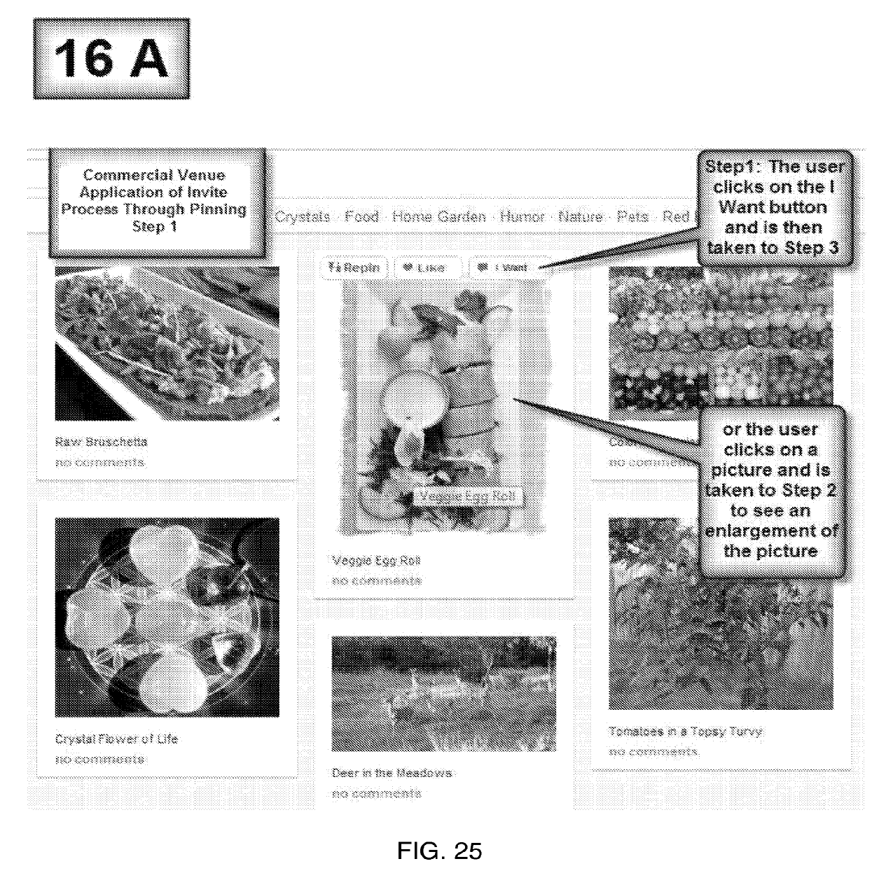

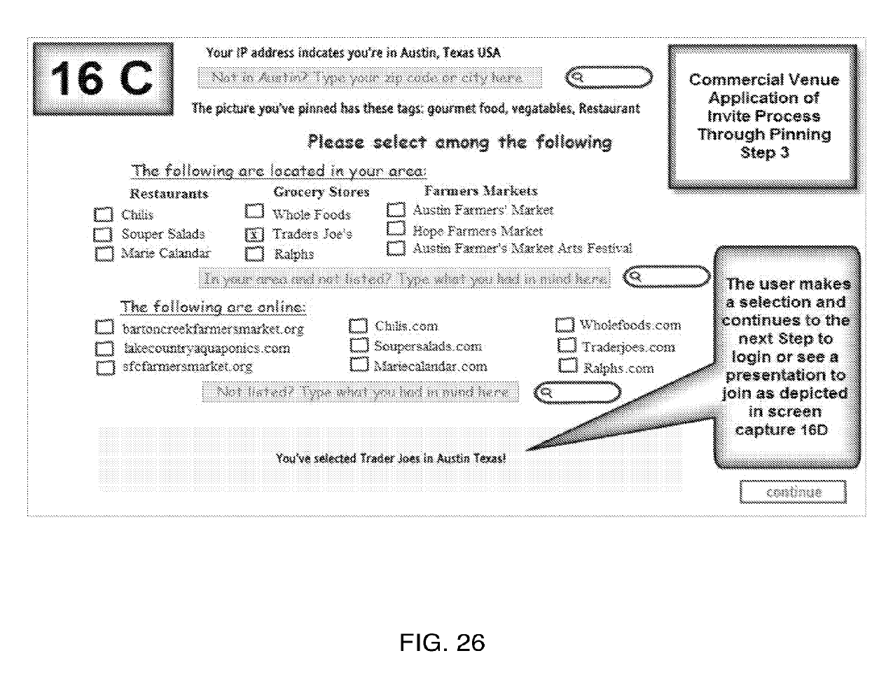

In yet another embodiment, a referral link to the social referral network can be generated in response to an online pinning process. One example of such a process is illustrated by the screen shot of FIGS. 25 to 27. In FIG. 25 a commerce venue application through pinning begins—step 1 in this scenario a picture is tagged as commercial, the user can indicate if they like it, want or desire it and subscribe to it and refer it to others with the referral social network process. Commercial venue(s) can have license(s) with the referral social network. Commercial venue application through pinning—step 2 User looks at an enlargement of a picture that has been selected from the user interface shown in FIG. 25.

Commercial venue application through pinning—step 3 User's location has been identified from IP address and physical and web options are displayed for selection (see FIG. 26). Commercial venue(s) can have license(s) with referral social network. If user is a referral social network member then the member's location and payment information is available using the referral social network authorization process and local participating commercial venue(s) are displayed as appropriate.

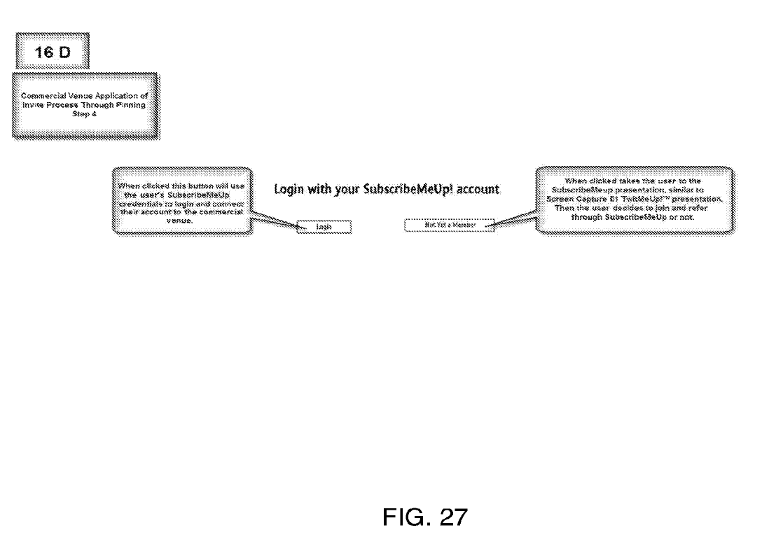

Commercial venue application through pinning—step 4 login or presentation buttons (see FIG. 27). The user either logs in with referral social network authorization process providing the user's referral social network information (location and payment information) or the user will see a presentation to join the referral social network or a non-profit or commercial venue that is licensed to use the referral social network.

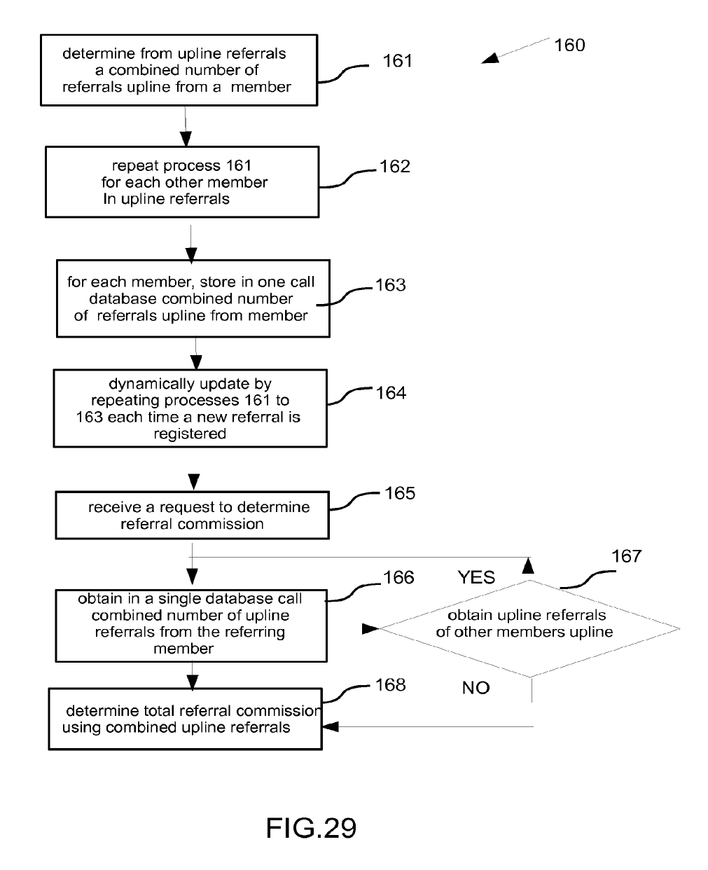

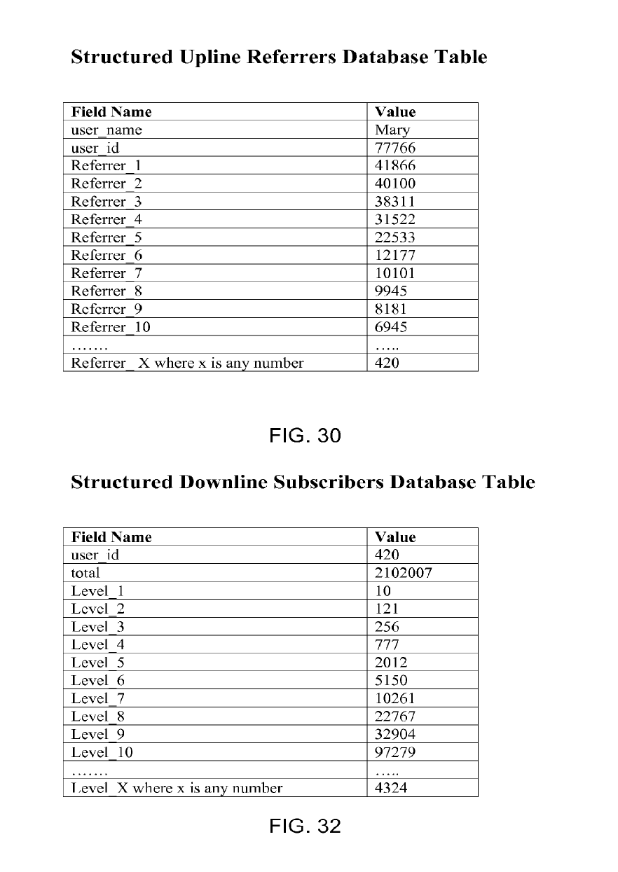

As mentioned hereinbefore, the process of determining referral commissions in the methods for monetization of the referral social network according to embodiments can be performed in different ways. A method for determining referral commission based on referral relationships in the online referral social network according to one embodiment will now be described with reference to FIG. 29 which is a flow chart outlining the method 160. System 1 determines from a referral chain information a combined number of referrals upline from a particular member in the referral chain (process 161). Process 161 then repeats for each other member in the chain (process 162). For each member upline from the particular member, the system stores in a one call database the number of their referrals (process 163). One non-limiting example of such a one call upline database is represented in table format in FIG. 30.

In one embodiment, system 1 can implement processes 161 to 163 dynamically by incrementing the number of upline referrals for each member as a result of each new member being registered in the online referral social network (process 164) according for example to process 115 of method 110.

System 1 then receives a request to determine referral commission for distribution among one or more members in a referral chain as a result of a particular member performing a referral (process 165). In one embodiment, system 1 receives a referral commission determination request which has been generated internally in response to the system registering a new member to the referral network according to for example process 115 of method 110. In another embodiment, system 1 receives a referral commission determination request that has been generated externally for example by a user of a user device wishing to view referral commissions. System 1 then obtains in a single database call the total number of referrals associated with a particular member that is making a referral (process 166). System 1 can then determine a commission payable to the particular referring member (process 168) and, if desired, other members, according to the total number of referrals obtained for the particular member (process 167,168). The system can determine the commission payable according to different commission models. In the example of FIG. 29, system 1 determines the total referral commission (process 168). Determining the total referral commission can be achieved for example by looking up a pre-fixed commission in the system or setting the total referral commission according to the total number of referrals.

In one embodiment, system 1 can distribute referral commission among a particular member and other members in the referral chain. For example, for a particular member making a referral, system 1 can obtain in a single data base call the total referrals associated with the particular member, and then obtain in another single database call the total referrals for a member upline from the particular member in the referral chain, then repeat this process for each other member upline. System 1 can then retrieve the total upline referrals associated with each member upline from the particular member and then distribute the referral commission among the particular member and these upline members according to the distribution of total commissions of each of these members.

Referring in more detail to the one call database system utilized in process 166, an exemplary upline database table of such a one call database system is shown in FIG. 30. This database table keeps record of the user_id of each member in the user's structured upline genealogy. With the structure of the Structured Upline Referrers Database table, it is possible that just one simple database call can retrieve the user_id of the member's Upline referrers up to “x” number of referrers. With this one call database, only the member's direct referrer is recorded which results in much longer access time to find all “x” number of Upline Referrers. So for example, to find the Mary's 100^{th} Upline referrers, a database call would find
Referrer_{—}1 (user_id=41866)
then find Referrer_{—}1's referrer (Referrer_{—}2=40100) and
then find Referrer_{—}2's referrer (Referrer_{—}3=38311)
and so on until referrer_{—}10 is found.

In the example above, the number of database calls is 100.

As the one call database of FIG. 30 scales up in size due to larger and larger number of users, this database table structure saves a tremendous overhead of database calls. The less database calls, the faster the web page request is served.

In the example of FIG. 30, the number of Upline referrers maintained in the table is “x”. In the current implementation, the actual number is 100. But there is no theoretical limit to “x”, simply a matter of practical size (and performance, i.e., speed of the database, and it can be adjusted as the number of users of the invention increases over time (and more capable hardware is deployed.

Any time a user, such as Mary, makes a commissionable product purchase or buys advertising or services, the commission compensation is distributed amongst a configurable number of levels in the Upline database structure.

The upline database may store these relationships between individuals as a table, or as a simple linked list of pointers to storage locations or memory locations containing the relevant data for each entry in the list.

Whilst the embodiments described above with reference to method 160 and one call database table FIG. 30 refer to upline referrals, in other embodiments of these methods and one call databases, referrals can be downline referrals or a combination of upline and downline referrals. Furthermore, in another embodiment, the method of obtaining combined referrals in a single database call can be utilized in processes other than determining referral commissions payable to members. For example, in one embodiment, the method of obtaining total referrals in a single database can be utilized for the purpose of generating user interface upline or downline images including referral numbers and alternatively or additional commissions earned. Such generated user interface upline and/or downline images can be for example included in a user interface dashboard such as dashboard 80.

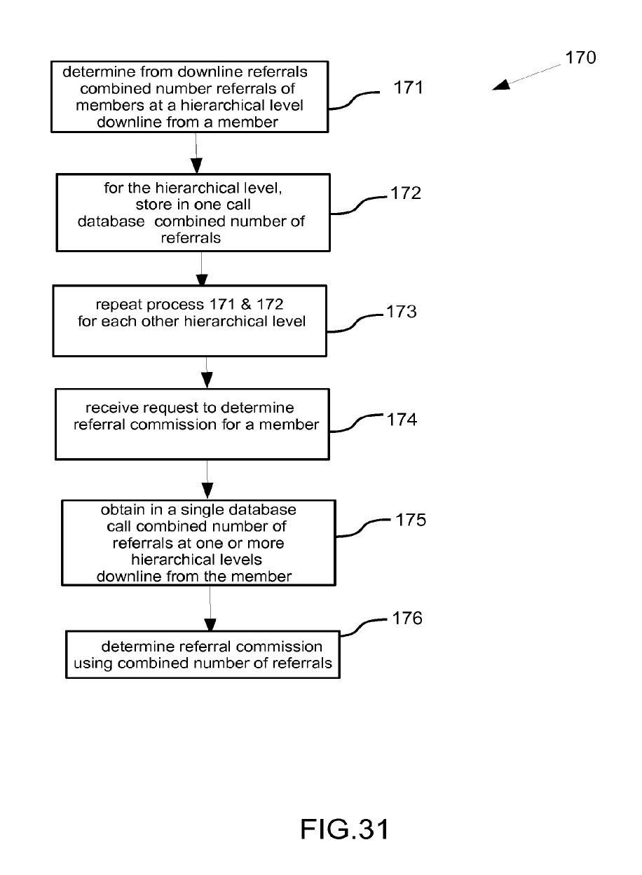

A method for determining referral commission based on referral relationships in the online referral social network according to another embodiment will now be described with reference to FIG. 31 which is a flow chart outlining method 170. System 1 determines the number of downline referrals for each member in a referral chain or other organizational structure (process 171). For each referral chain or other organizational level, the total number of referrals downline from members at the same level is stored in the one call database (process 172). Processes 171 & 172 are repeated for each other level (process 173). System 1 receives a referral commission determination request (process 174). In one embodiment, system 1 receives a referral commission determination request which has been generated internally in response to the system registering a new member to the referral network according to for example process 115 of method 110. In another embodiment, system 1 receives a referral commission determination request that has been generated externally for example by a user of a user device wishing to view referral commissions. System 1 then obtains in a single database call the total number of downline referrals for all members at a particular level in the referral chain (process 175). System 1 then determines a referral commission payable to the referring member and, if desired, other members downline, utilizing the combined number downline referrals for all members at a particular level in the referral chain (process 176).

Referring in more detail to a one call database system utilized in process 170, an exemplary upline database table of such a one call database system is shown in FIG. 32. This database table keeps record of the number of subscribers in each of the organizational levels in the user's structured Downline genealogy. With the structure of the Structured Downline Subscribers Database table, it is possible that just one simple database call can retrieve the number of Downline subscribers a member has, up to “x” levels down. Without this one call database, only the total number of the user's personal referrals or subscribers is recorded. So for example, to find the total number of subscribers resulting from the user's 10^{th} organizational level, these are the database calls to get that number: get total personal referrals (Level_{—}1=10)
1. for each of the 10 users found in step 1, get their total personal referrals.
   (10 database calls, Level_{—}2=121)
2. for each of the 121 users found in step 2, get their total personal referrals.
   (121 database calls, Level_{—}3=256) 3. for each of the 256 users found in step 3, get their total personal referrals.
   (256 database calls, Level_{—}4=777)
4. for each of the 777 users found in step 4, get their total personal referrals.
   (777 database calls, Level_{—}5=2012)
5. for each of the 2012 users found in step 5, get their total personal referrals.
   (2012 database calls, Level_6=5150)
6. for each of the 5150 users found in step 6, get their total personal referrals.
   (5150 database calls, Level_{—}7=10261)
7. for each of the 10261 users found in step 7, get their total personal referrals.
   (10261 database calls, Level_{—}8=22767)
8. for each of the 22767 users found in step 8, get their total personal referrals.
   (22767 database calls, Level_{—}9=32904)
9. for each of the 32904 users found in step 9, get their total personal referrals.
   (32904 database calls, Level_{—}10=97279)
Total number of database calls without the invention: 74,258
Total number of database calls using the invention: 1
   In the example in the above scenario without the one call database, the number of database calls grows exponentially and quickly becomes impractical.

But with the one call database of embodiments, it only takes 1 database call to get that information. As the one call database scales up in size due to larger and larger number of users, this database table structure saves a tremendous overhead of database calls. The less database calls, the faster the web page request is served.

In this example, the number of Downline Subscriber Levels maintained in the table is “x”. In the current implementation, the actual number is 100. But there is no theoretical limit to “x”, simply a matter of practical size (and speed) of the database, and it can be adjusted as the number of users of the invention increases over time (and more capable servers are deployed)

A method of operating the dashboard user interface 80 of the social network for exploring referral relationships will now be described. In response to receiving a selection of the referrals viewer 88, dashboard shows individual member profiles of members whom the member using dashboard 80 has successfully referred (i.e. profiles of the individual members of the chain of downline members shown on). Messaging functionality is included in this manager to allow a member to contact any of these members by clicking on their member profile and selecting message to open a live chat, send email, follow selected member and other suitable communication mechanisms. In response to receiving a selection of the referrals viewer 89, dashboard shows specific individual member profiles of the member's upline tree (i.e. profiles of members who would be shown in the chain displayed by upline manager). Thus, while upline manager 83 and downline manager 84 can be utilized to show the member his or her upline tree and downline tree, respectively, referred manager 89 and referrals manager 88 show individual member profiles of members of the upline tree and downline tree, respectively. The upline and/or downline images can be as described hereinbefore.

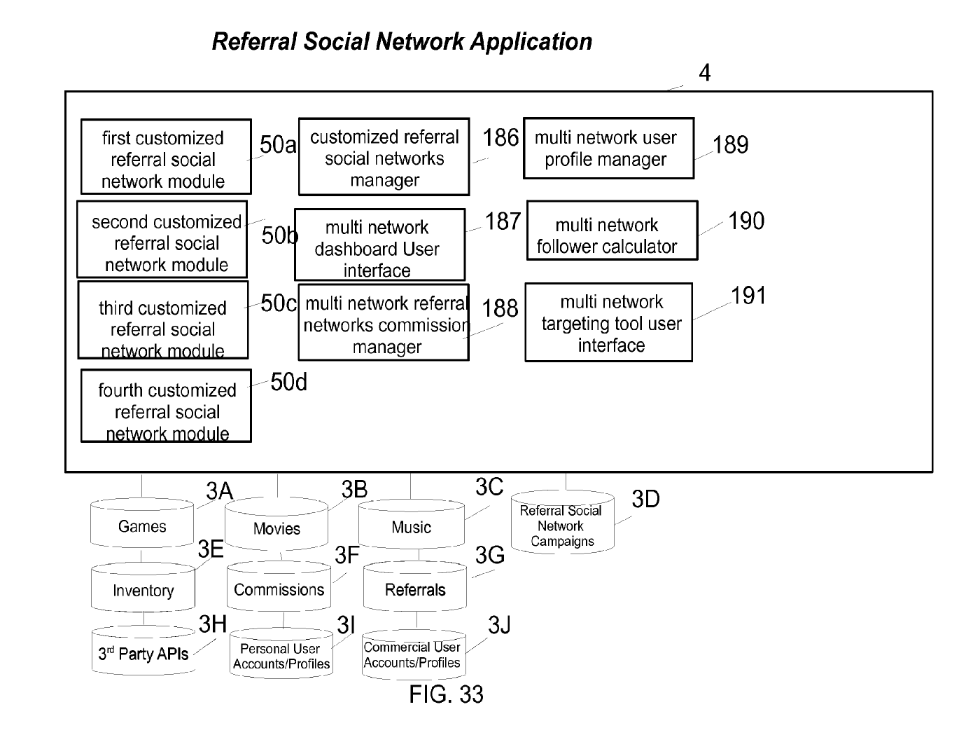

Reference will now be made to another aspect of a referral social network system in which the system is as a multi referral social network. By way of example to FIG. 33, in one embodiment, the referral social network application module 4A comprises a plurality of referral social networks modules 50a -50d, each providing an individual customized referral social network. Each referral social network of the plurality is similar to the referral social network of the embodiments describe hereinbefore but customized for use with a different external social network. For example, each module 50a-50d is customized to provide an interactive monetization presentation that includes generation of website referral campaigns, referral links and other features that are formatted specifically for use with a different type of external social network. For example, the first customized referral social network module can be customized for use with Twitter whereas the second customized referral social network module can be customized for us with facebook and so on. Each module 50a-50d includes modules that operate in a similar manner to the module 50 of FIG. 3.

As shown in FIG. 33, the referral social network application also includes customized referral social networks manager 186 configured to manage each of the customized referral social network modules 50a-50d, multi network dashboard user interface 187 configured to provide a user interface for user interaction with the application, multi network referral commission manager 188 configured to determine commission payable and earnable based on referrals made to one or more of the referral social networks provided by modules 50a-50d, multi network user profile manager 189 configured to manage user profiles from a plurality of the referral social networks, multi network follower calculator 190 configured to determine the referrals or potential referrals of a member across a plurality of the social referral networks, and multi network targeting tool user interface 191 configured to target members and/or followers connections of members across a plurality of the social referral networks.

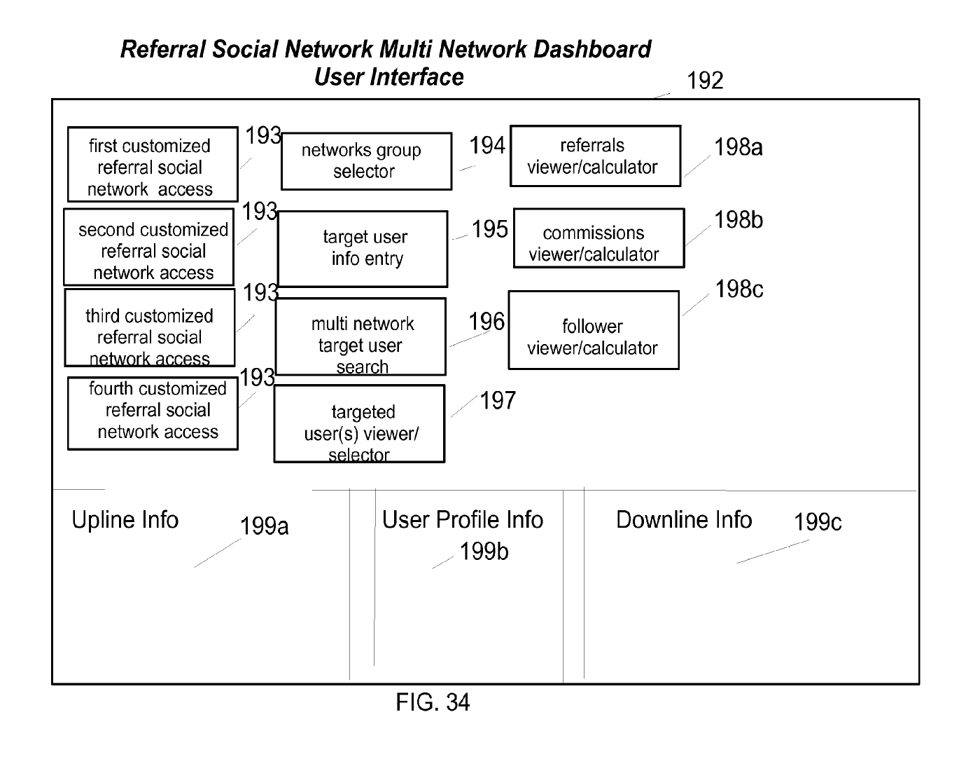

One example of the multi referral social network dashboard user interface for interacting with the multi referral social network application 4A is shown in FIG. 34. The user interface has buttons or icons 193, 194 for selecting and accessing one or more of the plurality of referral social networks. Users can click on a particular referral social network icon or use the networks group select to block select more than one of the plurality of referral social networks. Target user info entry interface field 195 can be utilized by a user to enter targeting information and the target user search 196 selected to perform a search on the information among the plurality of social networks. The user interface also includes a button for viewing/selecting particular users 197, and viewer/calculator buttons 198a-198c for viewing and/or calculating referrals, commissions, followers among the plurality of social networks. Furthermore, in one example, the user interface can include upline info 199a, user profile info 196b, and downline info 199c, for particular users targeted by the user interface in response to user instructions. Upline and downline info can comprise upline and downline images such as described hereinbefore for one or more particular selected social referral networks.

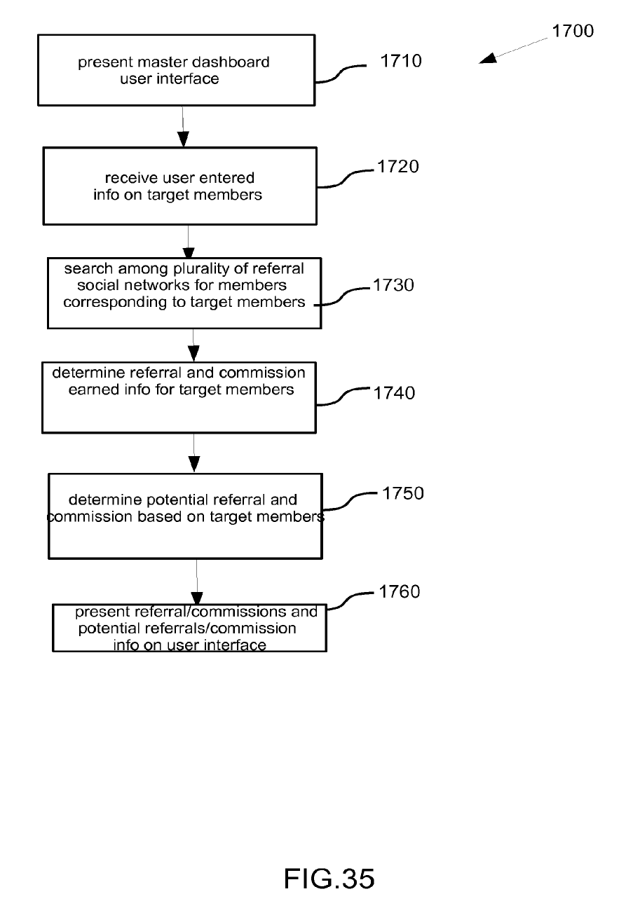

One example of a method for monetizing a multi referral social network implemented in the multi referral social network system according to one embodiment is illustrated in the flow chart 1700 of FIG. 35. In process 1710 the multi referral social network system generates and presents the multi network dashboard user interface, such as user interface of FIG. 34. The system receives user info on target members that the user has entered in the user device using the user interface (process 1720). The system searches among the plurality of customized referral social networks for members corresponding to target members (process 1730). The system then determines referral and/or commission earned and/or payable to target members found through the search (process 1740, 1750). Present and/or potential referrals/commission are then presented on the user interface for viewing. In this manner, a user can assess current and potential commissions/referrals of targeted users across a plurality of the customized referral social networks for assessing the quality of the network and potential impact of future referral campaigns on those targeted members across the plurality of networks. The methods for determining the referrals/commissions utilizing one call databases and described hereinbefore can be used to determine the referrals/commissions and ensure quick visualization of the information on the user interface. Both the number of user referrals to one or a plurality of the referral social networks as well as user referrals to goods/services can be included in upline/downline information on the multi network user interface (for example as shown and described hereinbefore for organizational chart 99) and the user can quickly view a selected targeted members profile on the same user interface.

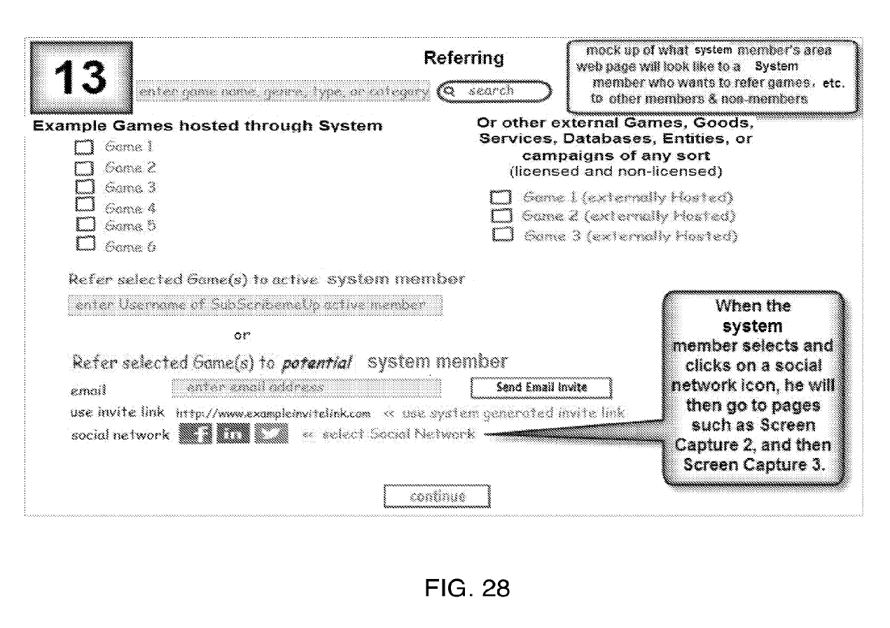

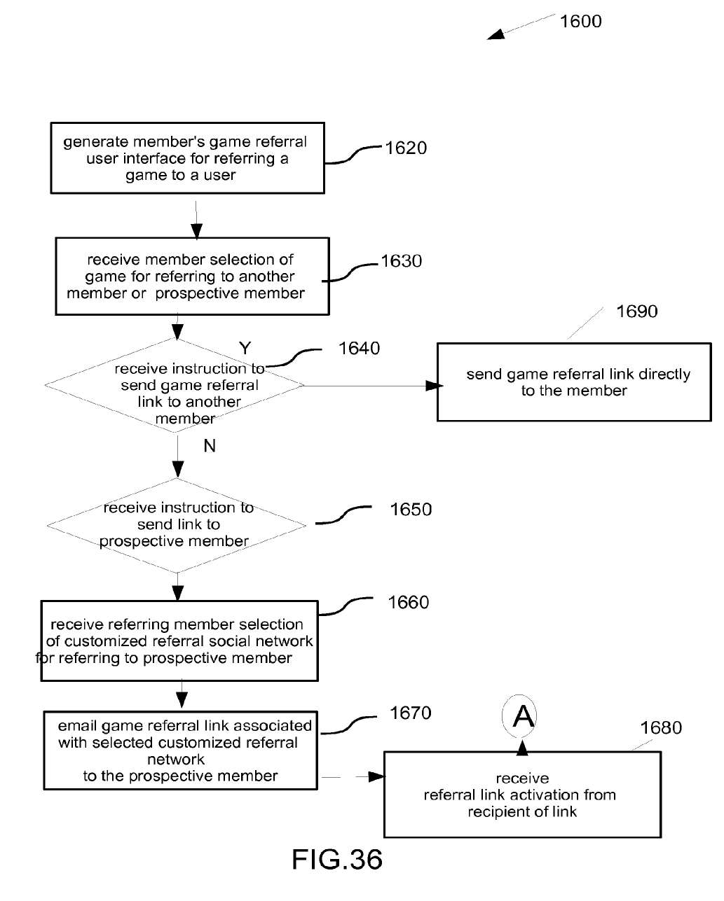

A method for monetizing a multi referral social network implemented in the multi referral social network system according to one embodiment will now be described with reference to FIG. 36. Method 1600 initiates by generating a member's game referral user interface for referring a game to a user (process 1620). One example of such as user interface is shown in FIG. 28. The system receives a member selection of one or more games that the member wishes to refer to another member or prospective member (process 1630). The system can receive a user entered instruction via the user interface to send a game referral link to another member (process 1640) or the prospective member (1650). Furthermore, the system can receive a selection identifying one of a plurality of the customized referral social networks (process 1660), for example by a user entered selection on the user interface. System 1 then e-mails a referral link associated with the selected customized referral network to the prospective member (process 1670). A referral activation is then received from a recipient of the link and the process of generating an interactive monetization presentation for the selected customized referral social network, such as shown processes 111-120 of FIGS. 16 & 17 initiates. Furthermore, in another example method 1600 can be implemented in a single referral network system, such as the referral social networks of other described embodiments, in which case the customized referral social network identification and association with the link would be omitted from processes 1660 and 1670.

In other embodiments, the goods/services being referred according to method 1600 can be goods/services other than games. Any goods/services, for example as described or envisaged herein with reference to other embodiments, can be referred instead of games. The goods/services can be hosted internally on the single referral social network as described herein, on the multi referral social network, or externally by an external entity/third party. In a no license scenario members of the single referral social network or multi referral social network can refer and promote games, goods and services that are either hosted through the system and/or they can refer and promote non-licensed games, goods and services (including non-profits and awareness campaigns that are external (not hosted through the system).

In yet another embodiment of a method for monetizing the multi referral social network, referral of a user to the multi referral social network system can be made by a referring member of one or more of the plurality of referral social networks of the system and the referring member is paid a commission for causing the user to upgrade by paying with at least one of the plurality of referral social networks.

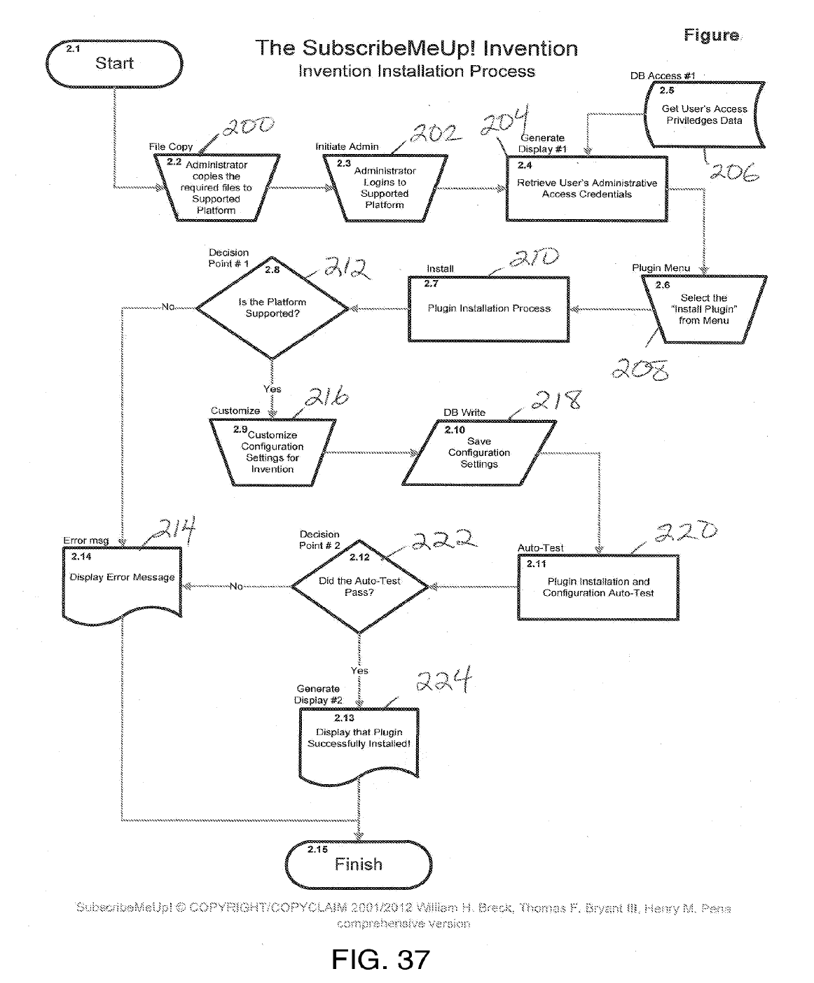

Directing attention to FIG. 37, there is shown a process for installing the software application of the online referral social network according to one embodiment. Beginning at process 200, the administrator copies files to the supported platform on which the referral social network runs. At process 202, the administrator logs in to the supported platform, and, at process 204 a display is generated that prompts the administrator to supply administrative access credentials (updating containing a post snippet). At process 206, access privilege data for the administrator is retrieved. Continuing to process 208, the administrator selects “install plugin” from a displayed menu. A plugin installation process proceeds at process 210. Continuing to decision process 212, a determination is made as to whether or not the platform on which installation is to be performed is supported or not. If it is not a supported platform, control transitions to process 214, where an error message is displayed, and the process terminates. Otherwise, in the case of a supported platform, control transitions to process 216, where the administrator may customize configuration settings for the referral social network. At process 218, configuration settings are saved to a database. At process 220, an auto-test of the plugin installation and configuration is made, At decision process 222, a determination is made as to whether or not the auto-test was successful, If not, control returns to process 214, where an error message is displayed, and the process terminates. Otherwise, in the case of a successful auto-test, control transitions to process 224, where a message is displayed to the administrator that the plugin was successfully installed, and the process terminates.

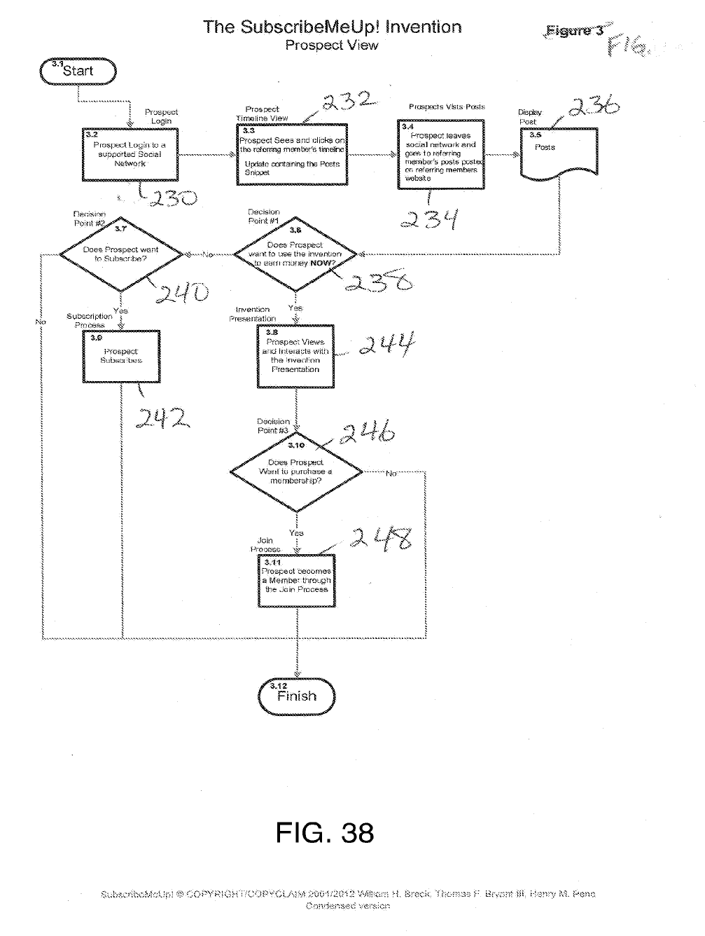

Directing attention to FIG. 38, a flow chart for a process for viewing prospects for the referral social network is illustrated. Beginning at process 230, a prospective member to a supported social network logs in. At process 232, the prospect timeline view, a prospective member sees and clicks on a referring member's timeline, displaying links to posts made by the referring member to the prospective member. System updates containing the posts snippet. At process 234, the prospective user clicks on the post links, and is taken from the social network to the referring member's posts posted on the referring member's website to view the referring member's posts which are displayed to the prospective member at process 236. In one example, this may be a website generated in the referral social network for the referring member such as a social campaign page. At decision process 238, a determination is made as to whether or not the prospective member wants to use the social referral network to earn money. If no, control proceeds to decision process 240, where a determination is made as to whether or not the prospective member wants to join the referral social network. If no, the process ends. If yes, the prospective member subscribes to the referral social network at process 242, and the process ends. Returning to decision process 238, if the prospective user chooses to make money, control proceeds to process 244, where the prospective member views and interacts with a presentation about the referral social network (see for example interactive presentation described hereinbefore). At decision process 246, a determination is made as to whether or not the prospective member wishes to purchase a membership to the referral social network. If yes, then the prospective member becomes a member through the join process, and the process ends. Returning to decision process 246, if the prospective member chooses not to join, process ends.

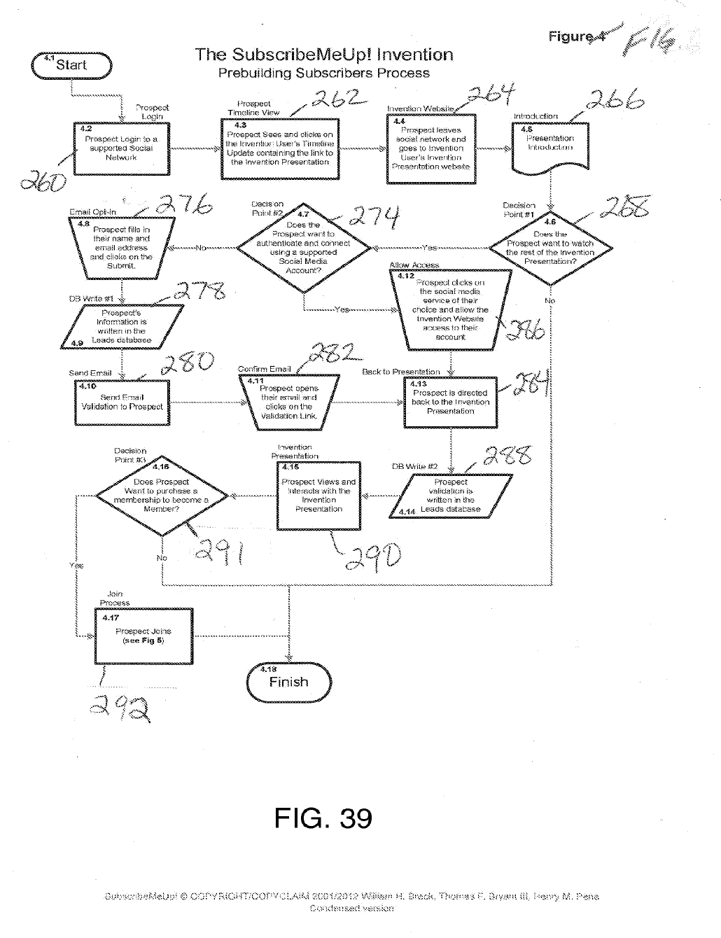

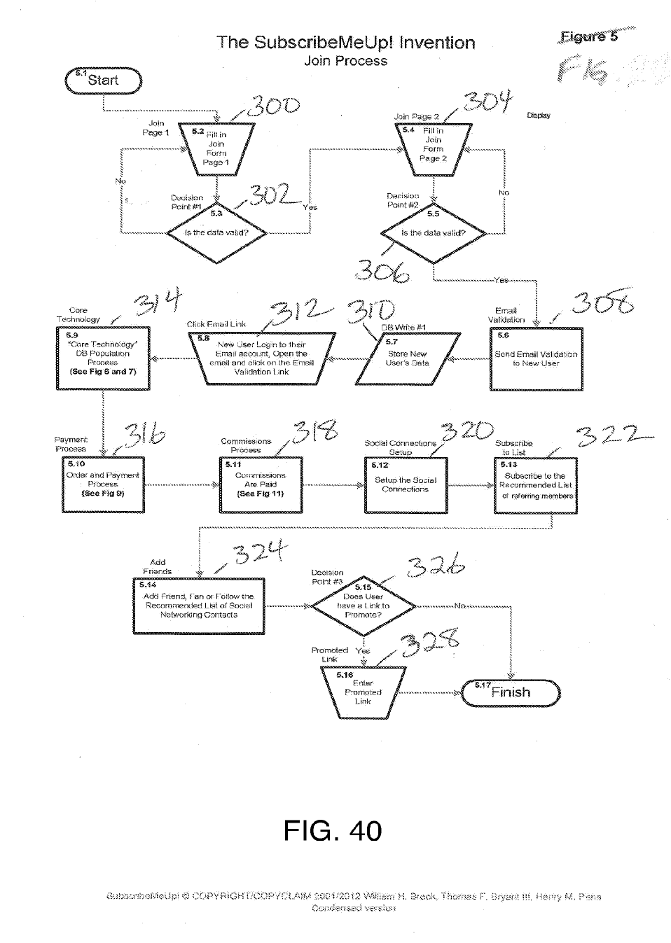

Directing attention to FIG. 39, a flow chart for a process to prebuilding subscribers to the referral social network according to embodiment is shown. Beginning at process 260, the prospective member logs in to a supported social network. At process 262, in the prospective timeline view the prospective member is shown a link to the presentation of the referral social network. In this example, prospect sees and clicks on user's social referral network timeline and the system sends an update containing the link to the referral network presentation (eg. monetization presentation described above or a referring members social campaign website generated in the referral social network). At process 264, the prospect interface view leaves the supported social network and connects to the referral social network. At process 266, the prospective member receives a presentation to the referral social network and/or other member's product or service, and, at decision process 268, a determination is made as to whether the prospective member wants to watch the rest of the presentation. If no, the process ends. If yes, then at decision process 274, a determination is made as to whether or not the prospective member wants to authenticate and connect to the referral social network using a supported social media account. If no, then control proceeds to process 276, an email opt-in action, where the prospective user fills in his or her name and email address and submits them to the referral social network. At process 278, the prospective member's information entered at process 276 is written to a leads database, and an email validation is sent to the prospective member at process 280. At process 282, the prospective member opens the email sent in process 280, and clicks on a validation link contained in the email. At process 284, the prospective member is directed back to the referral social network website and the presentation of referral social network and/or the other member's goods or service. Returning to decision process 274, if the prospective member chose to authenticate by a social media account, the prospective member clicks on the social media service of their choice and allows the referral social network to access their account at process 286. Control then proceeds to process 284, described above. Continuing to process 288, the prospective member validation is written to the leads database. At process 290, the prospective member views the social referral network presentation and interacts with the presentation. At decision process 291, a determination is made as to whether or not the prospective member wishes to purchase a membership to become a member. If no, the process ends. If yes, the prospective member joins at process 292 (see FIG. 40).

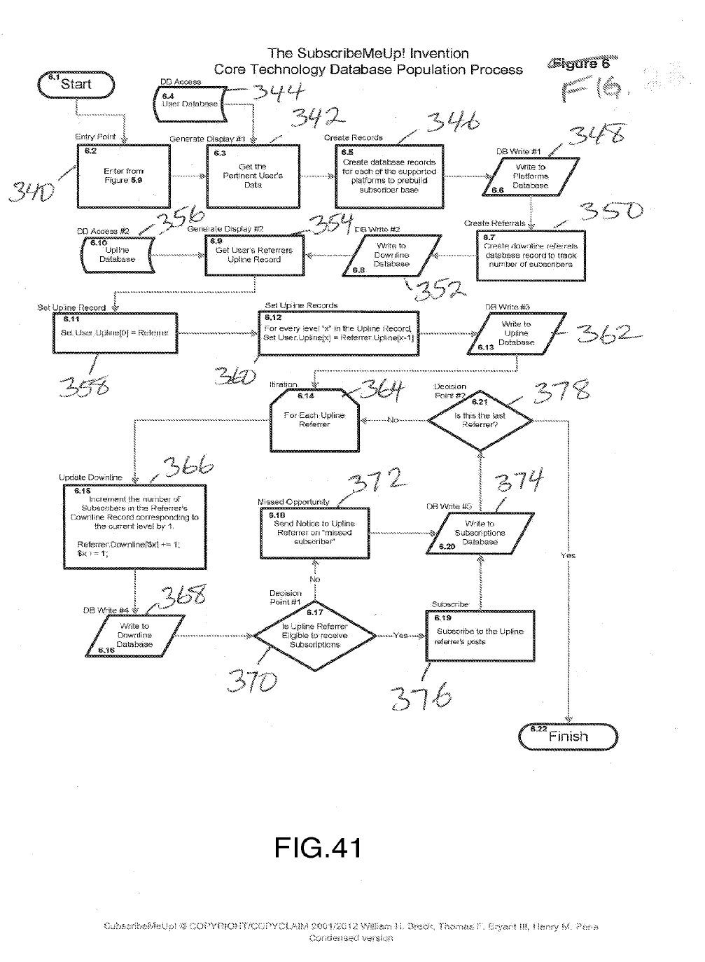

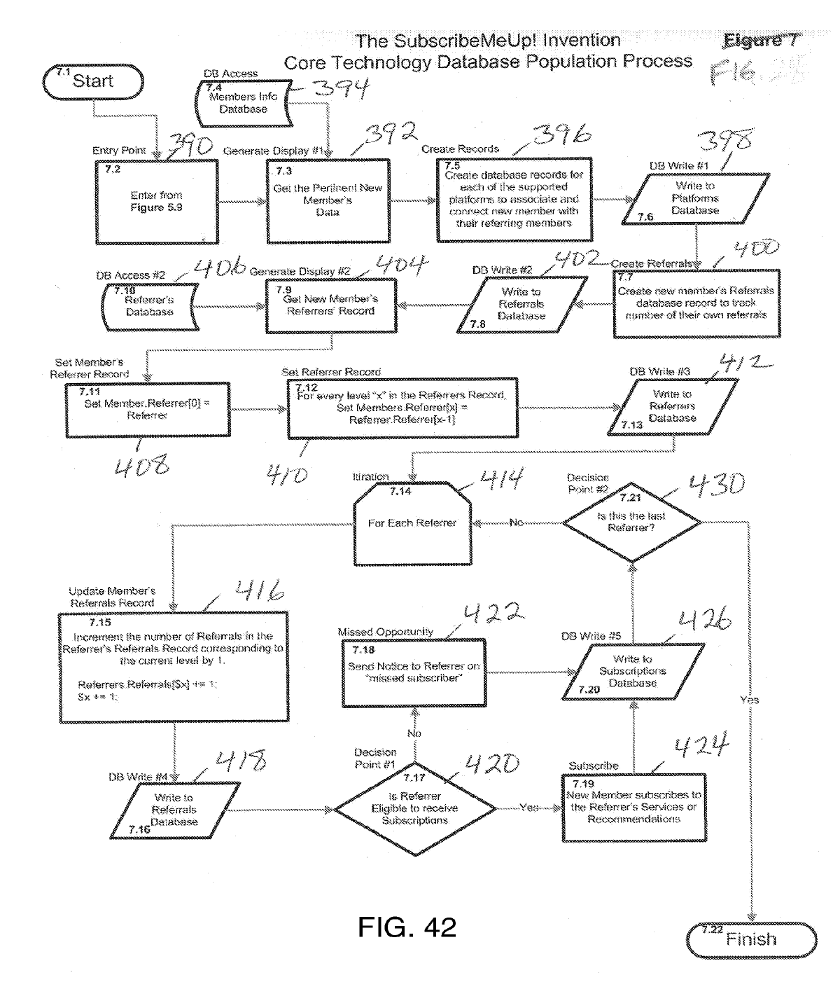

Directing attention to FIG. 40, a flow chart for a join process for a prospective member according to one embodiment is shown. At process 300, the prospective member, now referred to as a new user, fills in a join form. At decision process 302, a determination is made as to whether or not the data provided at process 300 is valid. If not, control loops back to process 300. Otherwise, control transitions to process 304, where the new user fills in additional data, which is also verified at process 306. At process 308, email validation is sent to the new user. At process 310, the new user's data is stored in user database 16. At process 312, the new user logs into his or her email account, opens the email sent at process 308, and clicks on the validation link contained in the email. Control proceeds to process 314, where the database process described below and illustrated in FIGS. 41 and 42 is performed. At process 316, an order and payment process is performed on behalf of the new user. At process 318, commissions are paid to referring members, described below and illustrated in FIG. 40. At process 320, social connections are set up, and relationships between members of the referral social network are recorded in referring member database 127. At process 322, the new user subscribes to the recommended list of referring members. At process 324, the new user is presented with choices of adding friends to the social network, declaring himself or herself to be a fan, or follow the recommended list of social networking contacts. At decision process 326, a determination is made as to whether or not the new user has a link to promote. If no, the process terminates. If yes, the new user's link is entered at process 328 for other users to follow. The process then terminates.

Directing attention to FIG. 41, a flow chart for a database population process is shown. At process 340, the process transitions from process 314 of FIG. 40. At process 342, pertinent user data is obtained from the new user by accessing a user database and displayed (process 344). At process 346, database records are created for each of the supported platforms to prebuild the subscriber base. At process 348, these database records are written to platforms database 17. At process 350, a downline referrals record is created to track the number of subscribers. At process 352, this record is written to upline database 18. At process 354, the user's referrers upline record is displayed upon its retrieval from upline database 18 (process 356). At process 358, the new user's upline record is set to identify a referring member (set user.upline[0]=referrer). At process 360, upline records are assigned to indicate referring members (for every level “x” in the upline record set user.upline[x]=referrer.upline[x−1]. At process 362, these assigned upline records are written to the downline database 18. At process 364, a control loop begins. For each upline referring member, the downline number for that member is incremented (process 366)(increment the number of subscribers in the referrer's downline record corresponding to the current level by 1; referrer.downline[$x]+=1;$x+=1), and the number is written to the upline database 18 (process 368). Then, at decision process 370, a determination is made as to whether or not the upline referring member is eligible to receive subscriptions. If no, a notice is sent to the upline referring member to indicate a missed subscriber at process 372, and this indication is written to the subscriptions database 20 at process 374. If yes, then the subscription is made for the new user to the upline referring member's posts at process 376, and this subscription is recorded in the subscriptions database 20 at process 374. At decision process 378, a determination is made as to whether or not this is the last referring member for the new user. If no, then the loop beginning at process 364 repeats for another referring member for the new user. If yes, then the process terminates.

Directing attention to FIG. 42, an alternative database population process, similar to the one shown in FIG. 41, is shown as a flow chart. The difference between FIG. 41 and FIG. 42 is that FIG. 42 shows subscription to posts, while FIG. 41 shows subscription to a referring member's services or recommendations. At process 390, the process transitions from process 314 of FIG. 40. At process 392, pertinent user data is obtained from the new member by accessing user database 16 (process 394). At process 396, database records are created for each of the supported platforms to associate and connect new member with their referring members to prebuild the subscriber base. At process 398, these database records are written to platforms database. At process 400, the new member's referrals record is created to track the number of the new member's referrals. At process 402, this record is written to referrals database.

At process 404, the new member's referrer's record is displayed upon its retrieval from the referral database (process 406). At process 408, the member's referrer record is set (set member. Referrer [0]=referrer). At process 410, for every level “x” in the referrers recorded set members. Referrers [x] =referrer. Referrer [x−1]. At process 412, these referrers records are written to referrers database. At process 414, a control loop begins. For each referrer, the member's referrals record is updated (increment the number of referrals in the referrer's referrals record corresponding to the current level by 1; referrers referrals [$x]+=1; $+=1;) (process 416), and the number is written to the referrals database 18 (process 418). Then, at decision process 420, a determination is made as to whether or not the referrer is eligible to receive subscriptions. If no, a notice is sent to the referrer member to indicate a missed subscriber at process 422, and this indication is written to the subscriptions database 20 at process 424. If yes, then the subscription is made for the new user to the referring member's services or recommendations at process 426, and this subscription is recorded in the subscriptions database 20 at process 424. At decision process 428, a determination is made as to whether or not this is the last referring member for the new user. If no, then the loop beginning at process 424 repeats for another referring member for the new user. If yes, then the process terminates.

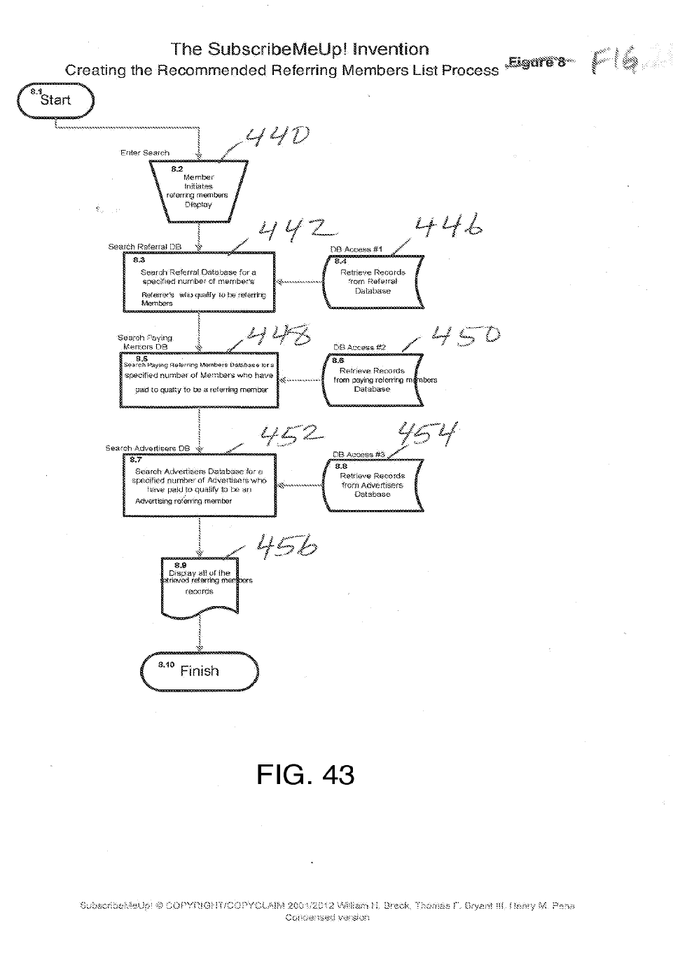

Directing attention to FIG. 43, a flow chart illustrating a process for creating a recommended referring members list according to one embodiment is shown. Beginning at process 440, a member of the referral social network initiates a referring member display. At process 442, the referral database is searched for a specified number of members who qualify as referring members. This triggers a retrieval of records from the referral database (process 446). At process 448, a search for a specified number of paying referring members, or members who have paid to qualify as referring members, is performed. This triggers a retrieval of records from paying referring members (stored in referring members database) at process 450. At process 452, advertising database is searched for a specified number of advertisers who have paid to qualify as advertising referring members. This triggers a retrieval of records from an advertising database at process 454. At process 456, all of the retrieved referring members records are displayed to the member who initiates the process at process 440, and then the process terminates.

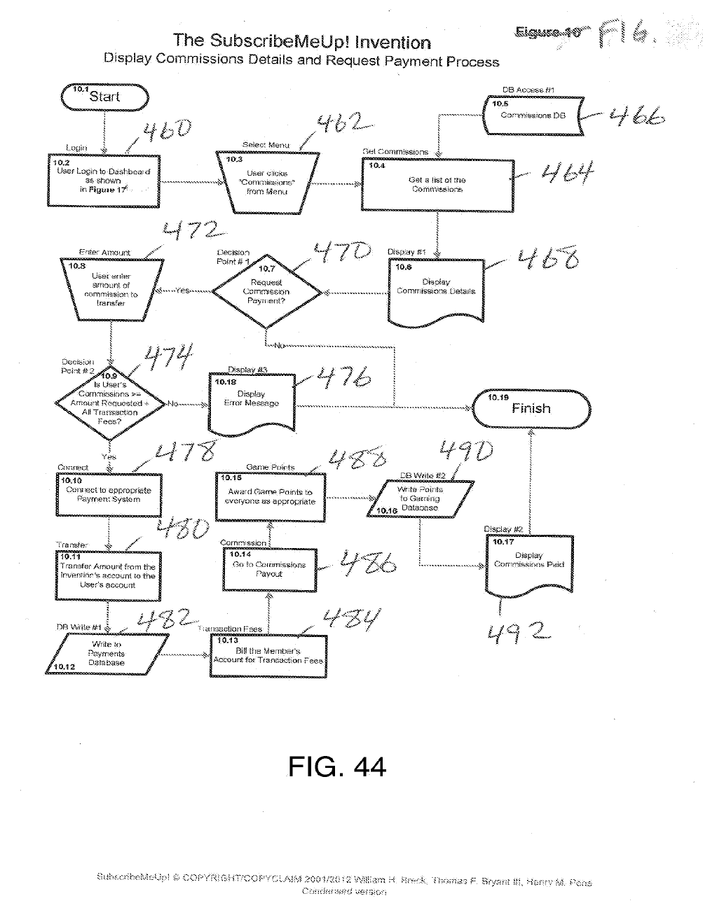

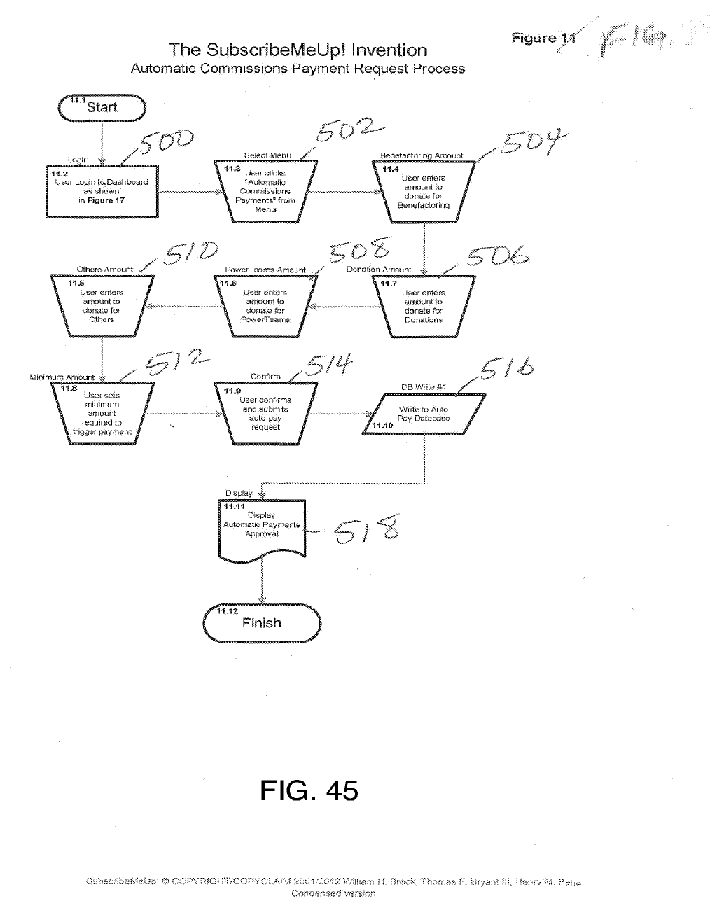

Directing attention to FIG. 44, there is shown a flow chart for performing a process for displaying commissions details and requesting payment of commissions according to one embodiment. At process 460, the member of the referral social network logs in. At process 462, the member selects “commissions” from a displayed menu. At process 464, a list of commissions accrued to the member is displayed, which is the result of accessing commissions database 26 at process 466. At process 468, commissions details are displayed to the member. At decision process 470, a determination is made as to whether the member requests to receive payment of the accrued commissions. If yes, then at process 472, the member is prompted to enter the payment amount desired. At decision process 474, a determination is made as to whether this requested amount is less than or equal to an amount available, such as commissions accrued minus all associated transaction fees. If no, then at process 476 an error message is displayed to the user and the process terminates. If yes, then control proceeds to process 478, where a connection is made to an appropriate payment system, such as an online bank, and, at process 480, the requested amount is transferred from an account, such as an account associated with the referral social network to the member's account. At process 482, this payout transaction is recorded in the payments database 25, and at process 484 transaction fees are paid out from the member's account. At process 486. A commissions payout process is invoked at process 488, which handles a secondary commission payout besides cash. For example, game points may be awarded to multiple members within a referral chain. In such an example, game points that are consumed when a member plays a game can be awarded to multiple members such as referring members who are upline from the member requesting commission payment, or members downline from the requesting member, or a combination, of both. In an embodiment, a member may also specify recipients of the secondary commission payout. At process 490 the secondary commission payout is recorded, for example, as game points paid out, to a secondary commissions database such as a gaming database 27. At process 492, the commissions paid are displayed to the requesting member, and the process terminates.

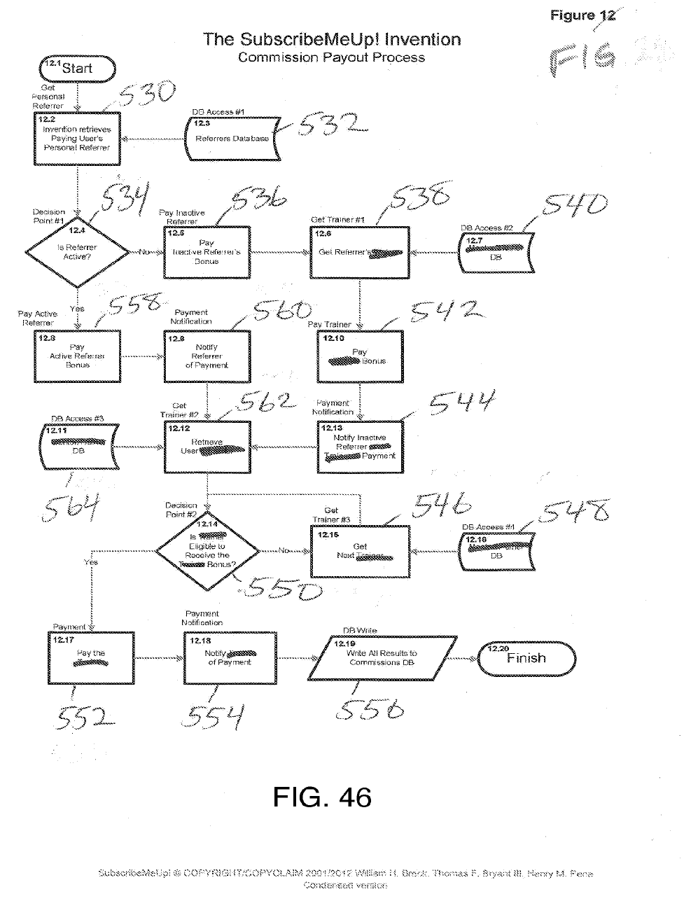

Commission payment can also be configured to occur automatically. Directing attention to FIG. 45, a flow chart illustrating a process for automatic commissions according to one embodiment is shown. At process 500, a member of the referral social network logs into the network. At process 502, the member selects “automatic commissions” from a menu of choices displayed to the member. At process 504, the member enters an amount to donate to a preselected recipient deemed a beneficiary by the member benefactor. At process 506, the member enters the amount to donate to a preselected recipient such as a charity organization. At process 508, the member enters an amount to donate for power teams. Another amount may be entered by the member at process 510 for an additional recipient or recipients. At process 512, the member sets a minimum amount to trigger an automatic payment of a commission. At process 514, the member confirms and submits the automatic payout request. At process 516, this configuration information regarding payout amounts, recipients, and minimum payment trigger is written to an auto pay database at process 516. Upon approval by the referral social network administration or accounting module of the referral social network, approval of this automatic payment request is displayed to the member at process 518.

An alternative commission payout process for paying members according to one embodiment is illustrated in a flow chart in FIG. 46. At process 530, a paying member's personal referrer is identified. This triggers a record to be retrieved from referring members database 22 at process 532. At decision process 534, a determination is made as to whether or not the personal referrer is active or inactive, which determines the size of a bonus paid to the personal referrer. If the referrer is inactive, at process 536 an inactive referrer bonus is paid to the referrer. At process 538, the referrer's trainer is identified. This triggers a record retrieval from referring members database 22 at process 540. At process 542, a bonus is paid to the trainer identified in process 540. At process 544, payment notification is made, where the inactive referrer and the trainer are notified of payments made to each party. Returning to decision process 534, if the referrer is active, an active referrer bonus is paid at process 558, payment notification is made to the referrer at process 560, and the paying member's trainer is identified at process 562 through a database access made to referring members database 22 at process 564. Control also transitions from process 544 to process 562. From process 562, control transitions to decision process 550, where a determination is made as to whether the trainer retrieved in process 562 is eligible to receive a trainer bonus. If not, control transitions to process 546, where another trainer is retrieved, triggering a database access to referring members database 22 (process 548), and control loops back to decision process 550. Once decision process 550 evaluates to yes, control transitions to process 552, where the trainer is paid a trainer bonus. At process 554, the trainer receiving the bonus is notified of the payment, and the results of all payments made in the process of FIG. 45 are recorded in a database write operation to commissions database 24 at process 556. The process then terminates.

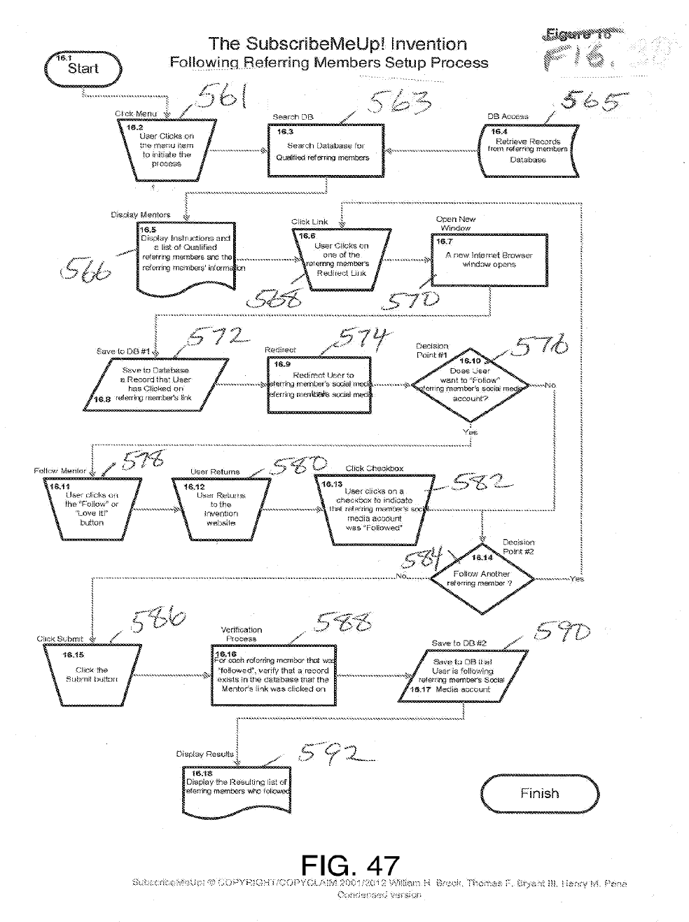

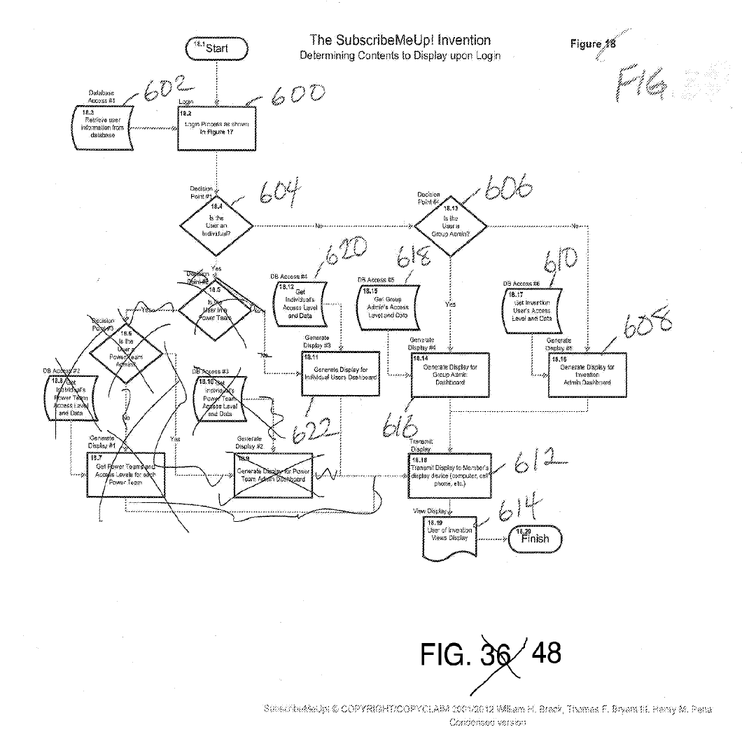

FIG. 47 illustrates a process for following referring members setup according to one embodiment. At process 561, a user clicks on a menu to follow a referring member. At process 563, referring members database 22 is searched for qualified referring members, which triggers retrieval of records of referring members from the referring members database at process 565. At process 566, instructions and a list of qualified referring members and their information are displayed to the user. At process 568, the user clicks on a redirect link for one of the qualified referring members on the list. At process 570, the user's browser program opens a new window, and a record showing that the user selected the referring member's link is written to a database at process 572. At process 574, the user is redirected in the window opened in process 570 to the referring member's social media website page. At decision process 576, a determination is made as to whether or not the user wants to follow the referring member's social media account. If yes, then control transitions to process 578, where the user can select to either follow the account or select “love it,” whereby the user simply adds a personal endorsement to the referring member's social media account. At process 580, the user returns to the website of the referral social network, and at process 582 the user selects an indication reflecting that the user has chosen to follow the referring member's social media account. Control then proceeds to decision process 584. Returning to decision process 576, if the user does not wish to follow the referring member's social media account, control then transitions to decision process 584. At decision process 584, a determination is made as to whether or not the user wishes to follow another referring member. If yes, control returns to process 568, and the process described above repeats. If no, then control transitions to process 586, where the user selects “submit,” and a verification process begins at process 588. For each referring member that was followed by the user, verification is made that a record exists in the database that the user's link was selected. At process 590, an indication is saved to the database that the user is following each referring member's social media account. At process 592, the resulting list of referring members who are followed by the user is displayed to the user. The process then terminates.

Directing attention to FIG. 48 a process for determining contents to display upon user login according to one embodiment is shown in flow chart form. At process 600, a user logs in to the referral social network. At this point, the user can be one of several different types: an individual who may or may not be a member; a group administrator; or an individual member. Process 600 triggers a retrieval of user information from user database 16 at process 602. At decision process 604, a determination is made as to whether the user is an individual who may not be a member. If no, then at decision process 606, a determination is made as to whether the user is a group administrator. If no, then it is assumed that the user is a member, and at process 608 a display is generated for the referral social network. This display triggers retrieval from user database 16 of a record indicating the user's access level and user information process 610. At process 612, display generated at process 608 is transmitted to a member's device, such as a computer, smart phone, or other suitable device. At process 614, the user views the display and interacts with the referral social network until termination of the connection with the referral social network.

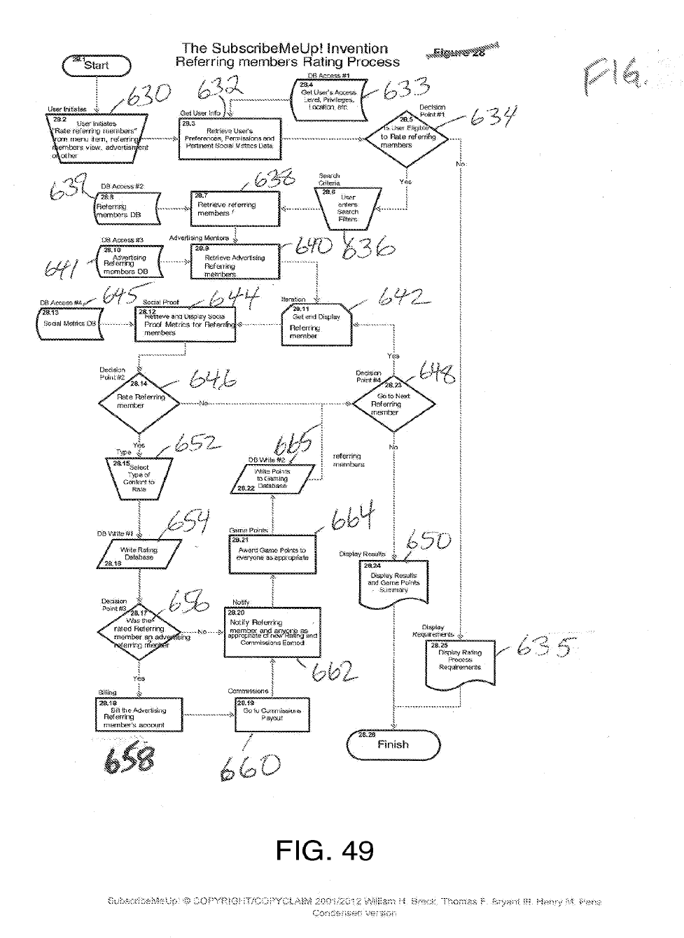

Directing attention to FIG. 49, there is shown a referring process for rating members of the online referral social network implemented by server system 10 according to one embodiment. Beginning at process 630, a user makes the selection of rate members 92 from dashboard 80. At acts 632-633, user database 16 is accessed to retrieve a member's preferences and permissions, and pertinent social metrics data is retrieved from social metrics database 30. At decision process 634, if the user is not eligible to rate referring members, then rating process requirements are displayed at process 635. However, if the user is eligible to rate referring members, as is the case typically for a member and his or her upline social network, control proceeds to process 636, where the user enters search filters. The search filters can be user-supplied, such as entering a period of time during which the upline referrals to be rated were active, or by number of levels upstream, as would allow a user to rate someone who referred someone who referred the member. In an embodiment, this is achieved by searching all branches of the upline personal network for two linked records terminating with the member's own record I within the upline tree. Other numbers of linked records terminating with the member's own record, such as three, or four, etc, can retrieve member profiles at any level of the upline tree based on number of traversals corresponding to number of linked records. In an embodiment, a filter can also include selected topics of interest that would select different members of the upline tree based on content rather than level. At process 638, the member profiles matching the search filters are returned, after they are retrieved from user database 16 at process 639. At process 640, advertising referring members are identified and retrieved from advertising referring members database 22 at process 641. At loop process 642, an execution loop begins, where referring member profiles in the retrieved plurality are presented individually. At 644, social proof metrics for referring members is displayed. This triggers an access of social metrics database 30 at process 645. At decision process 646, the user chooses to rate the displayed referring member or go to the next referring member profile in the list. If the user selects no, control transitions to 648, where the user chooses between the next profile or displaying results of the current rating session (loop process 642), such as how many profiles were rated, a breakdown of ratings and their frequency in the rating session, and other suitable information to the user. Returning to decision process 648, choosing to go to the next referring member returns to loop process 642. Returning to decision process 646, if the user chooses to rate the referring member whose profile is currently displayed, control proceeds to process 652, where the user selects the type of content to rate. Multiple aspects of a referring member can be rated separately or in combination, so such selection takes place here either through selection lists or icons, etc. At 654, the rating given is written to referring members database 22, and control proceeds to decision process 656. At process 656, if the rated referring member is an advertising referring member, the advertising member's account is billed for a rating service fee. At process 660, a commission is awarded to the user for rating the referring member. At process 662, the referring member who was rated at process 654 is notified of the rating and optionally of the commission paid to the user. At optional process 664, game points are awarded to the user, and/or other members associated with the user by either their upline or downline relationships. At process 665, points are written to gaming database 27. Control then returns to decision process 648.

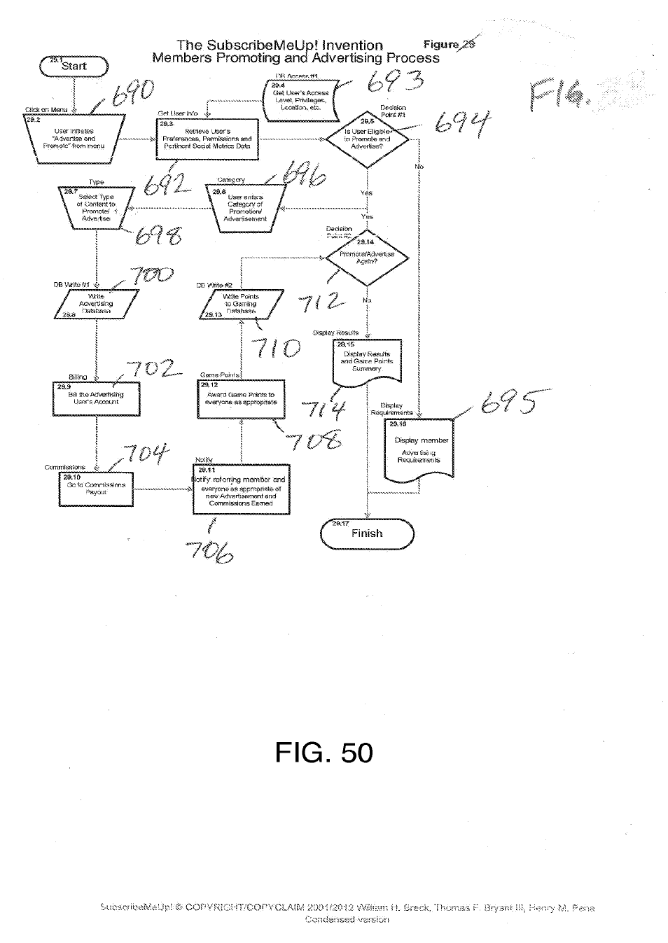

FIG. 50 shows a process for members promoting and advertising on the online referral social network implemented on server system 10 according to one embodiment. As the online referral social network focuses on referrals between members, members find it useful to promote, recommend and advertise the subject matter of their referrals made to other members. Beginning at process 690, a user selects advertise and promote/recommend 93 from dashboard 80. Control proceeds to process 692, where the user's preferences and permission and pertinent social metric data are retrieved, causing database access(es) at process 693. At process decision process 694, if the user is not eligible to promote/recommend and advertise, control transitions to process 695, where promotion and advertisement requirements are displayed to the user. Otherwise, control proceeds to process 696, where the user enters the category or categories of promotion and/or advertisement. Control proceeds to process 698, where the user selects the type of content to promote/recommend and/or advertise. At process 700, these selections are written to advertising database 23, and the user's account is billed at process 702. At process 704, control transitions to a commissions payout process, and at process 706 notification is sent to the referring member and others as appropriate is made as to the new advertisement and the commission paid. At process 708, game point awards are made to members as appropriate, and are written to the gaming database 27 at process 710. Control transitions to decision step 712, where the user can choose to exit, and be shown the results and game point summary at process 714. Otherwise, control returns to process 696 and proceeds as described above.

While preferred embodiments of the present invention have been described and illustrated in detail, it is to be understood that many modifications can be made to the embodiments, and features can be interchanged between embodiments, without departing from the spirit of the invention.

1. A computer implemented method for monetizing an online social network, comprising:
receiving, by the online referral social network from a user over a computer network, at least one communication requesting access to the online referral social network and/or at least one good or service;
receiving, by said online referral social network, at least one communication indicating a particular member of said online referral social network as having referred the user to said online referral social network;
confirming, by said online referral social network, a particular online referral social network member indicated in said at least one communication as having referred the user to the online referral social network is a member of said online referral social network;
determining, by said online referral social network, a referral commission; and
paying, by said online referral social network, a referral commission to at least the particular identified referring member.

2. The method of claim 1, wherein said receiving, by the online referral social network from a user over a computer network, said at least one communication comprises receiving said at least one communication in response to a user entered interface selection, on a user device, of a referring member link contained in an external social network user interface.

3. The method of claim 2, wherein said referring member link comprises a user timeline.

4. The method of claim 2, further comprising in response to receiving said at least one communication; sending, by said online social referral network, on said user device, an interactive user interface presentation demonstrating utilization of said online referral social network for monetizing said user's followers/connections.

5. The method of claim 1,
wherein said user is a member of said online social referral network and further comprising, sending by said online referral social network, a referring communication from said particular referring member to said user for referring said user to said good/service; and
wherein determining, by said online referral social network, a referral commission comprises determining a referral commission according to the referred good/service.

6. The method of claim 1, further comprising, sending by said online referral social network, a referring communication from said particular referring member to said user referring said user to said good/service; and
in response to receiving the at least one communication requesting a good/service; sending, by said online social network, at least one invite communication for inviting said user to register with said online social network;
receiving at least one registration communication from said user for registering in said online referral social network;
registering, by said online referral social network, said user as a new member in the online referral social network.

7. The method of claim 6, wherein determining, by said online referral social network, a referral commission comprises:
determining a first referral commission for referring the good /service;
and determining a second referral commission for referring said user to the referral online social network;
and determining a total referral commission based on said first referral commission and said second referral commission.

8. The method of claim 6 further comprising sending, by said online social referral network, on a user device of said user an interactive user interface presentation on utilization of said online referral social network for monetizing said user's followers/connections.

9. The method of claim 1 wherein said at least one communication comprises a communication for registering the user in the online social referral network;
and providing, by said online referral social network, an interactive referral presentation on utilization of said online referral social network for monetizing said user's followers/connections;
and registering, by said online referral social network, said user as a new member in the online referral social network.

10. The method of claim 9, wherein providing said interactive referral presentation comprises:
providing, by said online referral social network, an income calculator for determining potential commission earnable according to number of referrals sourced from said user.

11. The method of claim 9, further comprising
providing, by said online referral social network, a logon interface for said user to logon from an external online social network of said user;
receiving, by said online referral social network, user instruction to access information in the user's external social network account;
generating, by said online referral social network, a user profile for the new member in response to receiving user instructions including user personal interests.

12. The method of claim 1, further comprising
receiving, by said online referral social network, a personal interest search query;
searching, by said online referral social network, among member user profiles for members of the online referral social network having interests similar to queried personal interest; and
presenting, by said online social network, information on said members identified from searching as having said similar interests.

13. The method of claim 12, wherein providing, by said online social network, information on said members identified from searching as having said similar interests comprises presenting a recommendation list, said list listing for each member, the member identity and a corresponding follower link for linking to the external social network of the member and following the member through the external social network.

14. The method of claim 1, wherein determining said referral commission comprises
determining from referral information of said network a number of referrals downline and/or upline from each member;
for each member, storing in a one call database, a combined number of referrals downline and/or upline from the member;
obtaining in a single database call from the one call database the combined number of referrals upline and/or downline from the referring member;
determining a commission payable to said referring member utilizing said obtained combined number of referrals.

15. An apparatus for monetizing an online social network, said apparatus comprising:
a processor operably connectable to at plurality of user devices;
a data bus coupled to said processor;
a computer-usable medium embodying computer program code, said computer-usable medium being coupled to said data bus; and
said computer program code comprising instructions executable by said processor and configured for:
receiving, from a user over a computer network, at least one communication requesting access to the online referral social network and/or a good/service;
receiving at least one communication indicating a particular member of said online referral social network as having referred the user to said online referral social network;
confirming a particular online referral social network member indicated in said at least one communication as having referred the user to the online referral social network is a member of said online referral social network;
determining a referral commission; and
paying a referral commission to at least the particular identified referring member.

16. (canceled)

17. A computer implemented method for monetizing online social networks utilizing an online multi referral social network, the online multi referral social network comprising a plurality of referral social networks, each referral social network of said plurality being customized for use with a particular external social network; the method comprising:
receiving, by said online multi referral social network, at least one communication for registering said user with said selected customized referral social network; said at least one communication including an indication of a particular member of said online multi referral social network as having referred the user to the online multi referral social network;
confirming, by said online multi referral social network, a particular online referral social network member indicated in said at least one communication as having referred the user to the online referral social network is a member of said online multi referral social network;
determining, by said online multi referral social network, a referral commission; and
paying, by said online multi referral social network, a referral commission to at least the particular identified referring member.

18. The method of claim 17, further comprising selecting, by the online multi referral social network, one of said plurality of customized referral social networks in response to receiving a user interface entered selection over a computer network from a user device;
sending, by the online referral social network over a computer network, at least one communication referring a user to said selected customized referral social network.

19. The method of claim 18, further comprising for each one of plurality of members in said selected customized referral social network:
determining from referral information of the online referral social network a combined number of referrals downline and/or upline from a member; and
storing in a one call database, the combined number of referrals downline and/or upline from the member and the identity of the member;
receiving a request to determine a commission payable to at least a referring member;
in response to receiving the request, obtaining in a single database call from the one call database, the combined number of referrals upline and/or downline from the referring member; and
determining a commission payable to at least the referring member utilizing said obtained combined number of referrals.

20. The method of claim 18, further comprising paying said member said determined commission.

21-28. (canceled)
